(19) United States
(12) Patent Application Publication
(10) Pub. No.: US 2022/0089925 A1
(43) Pub. Date: Mar. 24, 2022

(54) AZEOTROPIC AND AZEOTROPE-LIKE COMPOSITIONS COMPRISING (E)-1,1,1,4,4,4-HEXAFLUOROBUT-2-ENE

(71) Applicant: THE CHEMOURS COMPANY FC, LLC, WILMINGTON, DE (US)

(72) Inventors: MARK L. ROBIN, MIDDLETOWN, DE (US); JASON R. JUHASZ, HOCKESSIN, DE (US); HARRISON K. MUSYIMI, BEAR, DE (US); LUKE DAVID SIMONI, WILMINGTON, DE (US)

(73) Assignee: THE CHEMOURS COMPANY FC, LLC, WILMINGTON, DE (US)

(21) Appl. No.: 17/420,183

(22) PCT Filed: Jan. 16, 2020
(86) PCT No.: PCT/US2020/013821

§ 371 Date: Jul. 1, 2021

Related U.S. Application Data
(60) Provisional application No. 62/793,593, filed on Jan. 17, 2019.

(51) Int. Cl. C09K 5/04

(52) U.S. Cl. CPC C09K 5/045; C09K 2205/32; F28F 2250/10; C09K 2205/126; C09K 2205/102; C09K 2205/24

(57) ABSTRACT

The present invention provides azeotropic and azeotrope-like compositions comprising E-1,1,1,4,4,4-hexafluorobut-2-ene with either ethanol or isopropanol that may be useful, for example, in heat transfer applications. Methods of using the compositions in refrigeration and heat transfer applications are also provided.

### CROSS-REFERENCE TO RELATED APPLICATIONS

This application claims the benefit of U.S. Provisional Application Ser. No. 62/793,593, filed Jan. 17, 2019, the disclosure of which is incorporated herein by reference in its entirety.

### TECHNICAL FIELD

The present invention relates to azeotropic or azeotrope-like compositions comprising E-1,1,1,4,4,4-hexafluorobut-2-ene that may be useful, for example, in heat transfer applications.

### BACKGROUND

Many industries have been working for the past few decades to find replacements for the ozone depleting chlorofluorocarbons (CFCs) and hydrochlorofluorocarbons (HCFCs). The CFCs and HCFCs have been employed in a wide range of applications, including their use as aerosol propellants, refrigerants, cleaning agents, expansion agents for thermoplastic and thermoset foams, heat transfer media, gaseous dielectrics, fire extinguishing and suppression agents, power cycle working fluids, polymerization media, particulate removal fluids, carrier fluids, buffing abrasive agents, and displacement drying agents. In the search for replacements for these versatile compounds, many industries have turned to the use of hydrofluorocarbons (HFCs), hydrofluoroolefins (HFOs), and hydrochlorofluoroolefins (HCFOs). The HFCs do not contribute to the destruction of stratospheric ozone, but are of concern due to their contribution to the “greenhouse effect”, i.e., they contribute to global warming. As a result, they have come under scrutiny, and their widespread use may also be limited in the future. Unlike HFCs, many HFOs and HCFOs do not contribute to the greenhouse effect, as they react and decompose in the atmosphere relatively quickly.

### SUMMARY

The present application provides, inter alia, compositions, comprising:

i) (E)-1,1,1,4,4,4-hexafluoro-2-butene; and

ii) a compound selected from ethanol and isopropanol;

wherein the ethanol or isopropanol is present in the composition in an amount effective to form an azeotrope or azeotrope-like composition with the (E)-1,1,1,4,4,4-hexafluoro-2-butene.

The present application further provides methods for producing cooling, comprising evaporating a composition provided herein in the vicinity of a body to be cooled, and thereafter condensing said composition.

The present application further provides methods for producing heating, comprising condensing a composition provided herein in the vicinity of a body to be heated, and thereafter evaporating said composition.

The present application further provides a heat transfer system or apparatus (e.g., a refrigeration, air-conditioning, or heat pump apparatus) comprising a composition provided herein.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

### DESCRIPTION OF DRAWINGS

FIG. 1 shows the Px diagram for E-HFO-1336mzz/ethanol at 29.88° C. The experimental data are provided as solid points. The solid line represents bubble point predictions using the NRTL equation. The dashed line represents predicted dew points.

FIG. 2 shows the Px diagram for E-HFO-1336mzz/isopropanol at 29.99° C. The experimental data are provided as solid points. The solid line represents bubble point predictions using the NRTL equation. The dashed line represents predicted dew points.

### DETAILED DESCRIPTION

To determine the relative volatility of any two compounds, for example, the PTx method can be used. In this procedure, the total absolute pressure in a cell of known volume is measured at a constant temperature for various compositions of the two compounds. Use of the PTx Method is described in detail in “Phase Equilibrium in Process Design”, Wiley-Interscience Publisher, 1970, written by Harold R. Null, on pages 124 to 126; hereby incorporated by reference. The resulting pressure vs. liquid composition data are alternately referred to as Vapor Liquid Equilibria data (or “VLE data.”)

These measurements can be converted into equilibrium vapor and liquid compositions in the PTx cell by using an activity coefficient equation model, such as the Non-Random-Two-Liquid (NRTL) equation, to represent liquid phase nonidealities. Use of an activity coefficient equation, such as the NRTL equation is described in detail in “The Properties of Gases and Liquids,” 4th edition, published by McGraw Hill, written by Reid, Prausnitz and Poling, on pages 241 to 387, and in “Phase Equilibria in Chemical Engineering,” published by Butterworth Publishers, 1985, written by Stanley M. Walas, pages 165 to 244. The collection of VLE data, the determination of interaction parameters by regression and the use of an equation of state to predict non-ideal behavior of a system are taught in “Double Azeotropy in Binary Mixtures of NH₃ and CHF₂CF₂,” C.-P. Chai Kao, M. E. Paulaitis, A. Yokozeki, Fluid Phase Equilibria, 127 (1997) 191-203. All of the aforementioned references are hereby incorporated by reference.

Without wishing to be bound by any theory or explanation, it is believed that the NRTL equation, together with the PTx cell data, can sufficiently predict the relative volatilities of the E-HFO-1336mzz compositions of the present invention and can therefore predict the behavior of these mixtures in multi-stage separation equipment such as distillation columns.

### Definitions and Abbreviations

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the term “consisting essentially of” is used to define a composition, method that includes materials, steps, features, components, or elements, in addition to those literally disclosed provided that these additional included materials, steps, features, components, or elements do not materially affect the basic and novel characteristic(s) of the claimed invention, especially the mode of action to achieve the desired result of any of the processes of the present invention. The term “consists essentially of” or “consisting essentially of” occupies a middle ground between “comprising” and “consisting of”.

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

As used herein, the term “about” is meant to account for variations due to experimental error (e.g., plus or minus approximately 10% of the indicated value). All measurements reported herein are understood to be modified by the term “about”, whether or not the term is explicitly used, unless explicitly stated otherwise.

Binary azeotropic or azeotrope-like compositions of substantially constant-boiling mixtures can be characterized, depending upon the conditions chosen, in a number of ways. For example, it is well known by those skilled in the art, that, at different pressures the composition of a given azeotrope or azeotrope-like composition will vary at least to some degree, as will the boiling point temperature. Thus, an azeotropic or azeotrope-like composition of two compounds represents a unique type of relationship but with a variable composition that depends on temperature and/or pressure. Therefore, compositional ranges, rather than fixed compositions, are often used to define azeotropes and azeotrope-like compositions.

As used herein, the term “azeotropic composition” shall be understood to mean a composition where at a given temperature at equilibrium, the boiling point pressure (of the liquid phase) is identical to the dew point pressure (of the vapor phase), i.e., X₂═Y₂. One way to characterize an azeotropic composition is that the vapor produced by partial evaporation or distillation of the liquid has the same composition as the liquid from which it was evaporated or distilled, that is, the admixture distills/refluxes without compositional change. Constant boiling compositions are characterized as azeotropic because they exhibit either a maximum or minimum boiling point, as compared with that of the non-azeotropic mixtures of the same components. Azeotropic compositions are also characterized by a minimum or a maximum in the vapor pressure of the mixture relative to the vapor pressure of the neat components at a constant temperature.

As used herein, the terms “azeotrope-like composition” and “near-azeotropic composition” shall be understood to mean a composition wherein the difference between the bubble point pressure (“BP”) and dew point pressure (“DP”) of the composition at a particular temperature is less than or equal to 5 percent based upon the bubble point pressure, i.e., [(BP−VP)/BP]×100≤5. As used herein, the terms “3 percent azeotrope-like composition” and “3 percent near-azeotropic composition” shall be understood to mean a composition wherein the difference between the bubble point pressure (“BP”) and dew point pressure (“DP”) of the composition at a particular temperature is less than or equal to 3 percent based upon the bubble point pressure, i.e., [(BP−VP)/BP]×100 s 3.

For purposes of this invention, “effective amount” is defined as the amount of each component of the inventive compositions which, when combined, results in the formation of an azeotropic or azeotrope-like composition. This definition includes the amounts of each component, which amounts may vary depending on the pressure applied to the composition so long as the azeotropic or azeotrope-like compositions continue to exist at the different pressures, but with possible different boiling points. Therefore, effective amount includes the amounts, such as may be expressed in weight percentages, of each component of the compositions of the instant invention which form azeotropic or azeotrope-like compositions at temperatures or pressures other than as described herein.

As used herein, the term “mole fraction” shall be understood to mean the ratio of the number of moles of one component in the binary composition to the sum of the numbers of moles of each of the two components in said composition (e.g., X₂=m2/(m1+m2).

### Chemicals, Abbreviations, and Acronyms

BP: bubble point pressure

DP: dew point pressure

HFC: hydrofluorocarbon

HCFC: hydrochlorofluorocarbon

HCFO: hydrochlorofluoroolefin

HFO-1336mzz(E) or (E)-1336mzz: (E)-1,1,1,4,4,4-hexafluorobut-2-ene

VLE: Vapor Liquid Equilibria

NRTL equation: Non-Random, Two-Liquid equation

### Azeotrope and Azeotrope-Like Compositions

The present application provides compositions, comprising:

i) (E)-1,1,1,4,4,4-hexafluoro-2-butene; and

ii) a compound selected from ethanol and isopropanol;

wherein the ethanol or isopropanol is present in the composition in an amount effective to form an azeotrope or azeotrope-like composition with the (E)-1,1,1,4,4,4-hexafluoro-2-butene.

In some embodiments, the composition comprises (E)-1,1,1,4,4,4-hexafluoro-2-butene and ethanol. In some embodiments, the composition consists essentially of (E)-1,1,1,4,4,4-hexafluoro-2-butene and ethanol. In some embodiments, the composition consists of (E)-1,1,1,4,4,4-hexafluoro-2-butene and ethanol. In some embodiments, the composition comprises (E)-1,1,1,4,4,4-hexafluoro-2-butene, ethanol, and one or more non-refrigerant components as described herein. In some embodiments, the composition consists of (E)-1,1,1,4,4,4-hexafluoro-2-butene, ethanol, and one or more non-refrigerant components as described herein.

In some embodiments, the composition comprising (E)-1,1,1,4,4,4-hexafluoro-2-butene and ethanol is an azeotrope composition (i.e., an azeotropic composition). In some embodiments, the composition comprising (E)-1,1,1,4,4,4-hexafluoro-2-butene and ethanol is an azeotrope-like composition.

In some embodiments, the composition comprises about 79 to about 97 mole percent (E)-1,1,1,4,4,4-hexafluoro-2-butene and about 21 to about 3 mole percent ethanol at a temperature of about 60° C. to about 131° C. and a pressure of about 88 psia to about 441 psia.

In some embodiments, the composition comprises about 82 to about 97 mole percent (E)-1,1,1,4,4,4-hexafluoro-2-butene and about 18 to about 3 mole percent ethanol at a temperature of about 60° C. to about 120° C. and a pressure of about 83 psia to about 365 psia.

In some embodiments, the composition comprises about 82 to about 97 mole percent (E)-1,1,1,4,4,4-hexafluoro-2-butene and about 18 to about 3 mole percent ethanol at a temperature of about 60° C. to about 120° C. and a pressure of about 83 psia to about 365 psia.

In some embodiments, the composition comprises about 72.8 to about 99.9 mole percent (E)-1,1,1,4,4,4-hexafluoro-2-butene and about 17.2 to about 0.1 mole percent ethanol at a temperature of about −40° C. to about 140° C. and a pressure of about 1.3 psia to about 507.9 psia.

In some embodiments, the composition comprises:

about 99.6 to about 99.9 mole percent (E)-1,1,1,4,4,4-hexafluoro-2-butene and about 0.3 to about 0.1 mole percent ethanol at a temperature of about −40° C. and a pressure of about 1.3 psia to about 1.4 psia; or

about 99.2 to about 99.9 mole percent (E)-1,1,1,4,4,4-hexafluoro-2-butene and about 0.8 to about 0.1 mole percent ethanol at a temperature of about −20° C. a pressure of about 4.1 psia to about 4.2 psia;

about 98.2 to about 99.9 mole percent (E)-1,1,1,4,4,4-hexafluoro-2-butene and about 1.8 to about 0.1 mole percent ethanol at a temperature of about 0° C. and a pressure of about 10.3 psia to about 10.7 psia; or

about 96.8 to about 99.9 mole percent (E)-1,1,1,4,4,4-hexafluoro-2-butene and about 3.2 to about 0.1 mole percent ethanol at a temperature of about 20° C. and a pressure of about 22.8 psia to about 23.5 psia; or

about 96.0 to about 99.9 mole percent (E)-1,1,1,4,4,4-hexafluoro-2-butene and about 4.0 to about 0.1 mole percent ethanol at a temperature of about 29.9° C. and a pressure of about 32.2 psia to about 33.1 psia; or

about 94.8 to about 99.9 mole percent (E)-1,1,1,4,4,4-hexafluoro-2-butene and about 5.2 to about 0.1 mole percent ethanol at a temperature of about 40° C. and a pressure of about 44.5 psia to about 45.9 psia; or

about 92.2 to about 99.9 mole percent (E)-1,1,1,4,4,4-hexafluoro-2-butene and about 7.8 to about 0.1 mole percent ethanol at a temperature of about 60° C. and a pressure of about 80.7 psia to about 82.9 psia; or

about 88.6 to about 99.9 mole percent (E)-1,1,1,4,4,4-hexafluoro-2-butene and about 11.4 to about 0.1 mole percent ethanol at a temperature of about 80° C. and a pressure of about 137.1 psia to about 141.0 psia; or

about 84.4 to about 99.9 mole percent (E)-1,1,1,4,4,4-hexafluoro-2-butene and about 15.6 to about 0.1 mole percent ethanol at a temperature of about 100° C. and a pressure of about 226.8 psia to about 233.4 psia; or

about 78.4 to about 99.9 mole percent (E)-1,1,1,4,4,4-hexafluoro-2-butene and about 21.6 to about 0.1 mole percent ethanol at a temperature of about 120° C. and a pressure of about 353.2 psia to about 364.0 psia; or

about 72.8 to about 99.9 mole percent (E)-1,1,1,4,4,4-hexafluoro-2-butene and about 27.2 to about 0.1 mole percent ethanol at a temperature of about 140° C. and a pressure of about 492.9 psia to about 507.9 psia.

In some embodiments, the composition is selected from the group of compositions provided in Table 2. In some embodiments, the composition is a composition provided in Table 2, wherein the temperature and azeotrope pressure are as shown in Table 2.

In some embodiments, the composition is selected from the group of compositions provided in Table 3. In some embodiments, the composition is a composition provided in Table 3, wherein the pressure and azeotrope temperature are as shown in Table 3.

In some embodiments, the composition is selected from the group of compositions provided in Table 4. In some embodiments, the composition is a composition provided in Table 4, wherein the temperature, bubble point pressure, and dew point pressure are as shown in Table 4.

In some embodiments, the composition is selected from the group of compositions provided in Table 5. In some embodiments, the composition is a composition provided in Table 5, wherein the temperature, bubble point pressure, and dew point pressure are as shown in Table 5.

In some embodiments, the composition is selected from the group of compositions provided in Table 6. In some embodiments, the composition is a composition provided in Table 6, wherein the temperature is as shown in Table 6.

In some embodiments, the composition comprises (E)-1,1,1,4,4,4-hexafluoro-2-butene and isopropanol. In some embodiments, the composition consists essentially of (E)-1,1,1,4,4,4-hexafluoro-2-butene and isopropanol. In some embodiments, the composition consists of (E)-1,1,1,4,4,4-hexafluoro-2-butene and isopropanol. In some embodiments, the composition comprises (E)-1,1,1,4,4,4-hexafluoro-2-butene, isopropanol, and one or more non-refrigerant components as described herein. In some embodiments, the composition consists of (E)-1,1,1,4,4,4-hexafluoro-2-butene, isopropanol, and one or more non-refrigerant components as described herein.

In some embodiments, the composition comprising (E)-1,1,1,4,4,4-hexafluoro-2-butene and isopropanol is an azeotrope composition (i.e., an azeotropic composition). In some embodiments, the composition comprising (E)-1,1,1,4,4,4-hexafluoro-2-butene and isopropanol is an azeotrope-like composition.

In some embodiments, the composition comprises about 83 to about 96 mole percent (E)-1,1,1,4,4,4-hexafluoro-2-butene and about 17 to about 4 mole percent ethanol at a temperature of about 80° C. to about 120° C. and a pressure of about 139 psia to about 350 psia.

In some embodiments, the composition comprises about 87 to about 99 mole percent (E)-1,1,1,4,4,4-hexafluoro-2-butene and about 13 to about 1 mole percent ethanol at a temperature of about 68° C. to about 108° C. and a pressure of about 103 psia to about 279 psia.

In some embodiments, the composition comprises about 81.4 to about 99.9 mole percent (E)-1,1,1,4,4,4-hexafluoro-2-butene and about 18.6 to about 0.1 mole percent ethanol at a temperature of about −20° C. to about 120° C. and a pressure of about 46 psia to about 330 psia.

In some embodiments, the composition comprises about 98.4 to about 99.9 mole percent (E)-1,1,1,4,4,4-hexafluoro-2-butene and about 1.6 to about 0.1 mole percent ethanol at a temperature of about 7.5° C. to about 7.8° C. and a pressure of about 14.7 psia.

In some embodiments, the composition comprises:

about 99.6 to about 99.9 mole percent (E)-1,1,1,4,4,4-hexafluoro-2-butene and about 0.4 to about 0.1 mole percent ethanol at a temperature of about −20° C. and a pressure of about 4.1 psia to about 4.2 psia; or

about 99.2 to about 99.9 mole percent (E)-1,1,1,4,4,4-hexafluoro-2-butene and about 0.8 to about 0.1 mole percent ethanol at a temperature of about 0° C. and a pressure of about 10.4 psia to about 10.7 psia; or

about 98.2 to about 99.9 mole percent (E)-1,1,1,4,4,4-hexafluoro-2-butene and about 1.8 to about 0.1 mole percent ethanol at a temperature of about 20° C. and a pressure of from about 22.8 psia to about 23.7 psia; or

about 97.6 to about 99.9 mole percent (E)-1,1,1,4,4,4-hexafluoro-2-butene and about 2.4 to about 0.1 mole percent ethanol at a temperature of about 29.9° C. and a pressure of about 32.1 psia to about 33.4 psia; or

about 96.6 to about 99.9 mole percent (E)-1,1,1,4,4,4-hexafluoro-2-butene and about 2.4 to about 0.1 mole percent ethanol at a temperature of about 40° C. and a pressure of about 44.4 psia to about 46.4 psia; or

about 94.0 to about 99.9 mole percent (E)-1,1,1,4,4,4-hexafluoro-2-butene and about 6 to about 0.1 mole percent ethanol at a temperature of about 60° C. and a pressure of about 79.4 psia to about 83.0 psia; or

about 90.4 to about 99.9 mole percent (E)-1,1,1,4,4,4-hexafluoro-2-butene and about 9.6 to about 0.1 mole percent ethanol at a temperature of about 80° C. and a pressure of about 133.9 psia to about 138.4 psia; or

about 85.8 to about 99.9 mole percent (E)-1,1,1,4,4,4-hexafluoro-2-butene and about 14.2 to about 0.1 mole percent ethanol at a temperature of about 100° C. and a pressure of about 217.9 psia to about 226.0 psia; or

about 78.6 to about 99.9 mole percent (E)-1,1,1,4,4,4-hexafluoro-2-butene and about 21.4 to about 0.1 mole percent ethanol at a temperature of about 120° C. and a pressure of about 329.6 psia to about 347.5 psia.

In some embodiments, the composition is selected from the group of compositions provided in Table 8. In some embodiments, the composition is a composition provided in Table 8, wherein the temperature and azeotrope pressure are as shown in Table 8.

In some embodiments, the composition is selected from the group of compositions provided in Table 9. In some embodiments, the composition is a composition provided in Table 9, wherein the pressure and azeotrope temperature are as shown in Table 9.

In some embodiments, the composition is selected from the group of compositions provided in Table 10. In some embodiments, the composition is a composition provided in Table 10, wherein the temperature, bubble point pressure, and dew point pressure are as shown in Table 10.

In some embodiments, the composition is selected from the group of compositions provided in Table 11. In some embodiments, the composition is a composition provided in Table 11, wherein the temperature, bubble point pressure, and dew point pressure are as shown in Table 11.

In some embodiments, the composition is selected from the group of compositions provided in Table 12. In some embodiments, the composition is a composition provided in Table 12, wherein the temperature is as shown in Table 12.

### Methods of Use

The compositions provided herein can act as a working fluid used to carry heat from a heat source to a heat sink. Such heat transfer compositions may also be useful as a refrigerant in a cycle wherein the fluid undergoes a phase change; that is, from a liquid to a gas and back, or vice versa. Examples of heat transfer systems include but are not limited to air conditioners, freezers, refrigerators, heat pumps, water chillers, flooded evaporator chillers, direct expansion chillers, walk-in coolers, high temperature heat pumps, mobile refrigerators, mobile air conditioning units, immersion cooling systems, data-center cooling systems, and combinations thereof. Accordingly, the present application provides a heat transfer system (e.g., a heat transfer apparatus) as described herein, comprising a composition provided herein. In some embodiments, the composition provided herein is useful as a working fluid (e.g., a working fluid for refrigeration or heating applications) in the heat transfer apparatus. In some embodiments, the compositions provided herein are useful in an apparatus or system comprising a high temperature heat pump. In some embodiments, the high temperature heat pump comprises a centrifugal compressor. In some embodiments, the compositions provided herein are useful in an apparatus or system comprising a chiller apparatus. In some embodiments, the compositions provided herein are useful in an apparatus or system comprising a centrifugal chiller apparatus. In some embodiments, the compositions provided herein are useful in a centrifugal high temperature heat pump.

Mechanical vapor-compression refrigeration, air conditioning and heat pump systems include an evaporator, a compressor, a condenser, and an expansion device. A refrigeration cycle re-uses refrigerant in multiple steps producing a cooling effect in one step and a heating effect in a different step. The cycle can be described as follows: Liquid refrigerant enters an evaporator through an expansion device, and the liquid refrigerant boils in the evaporator, by withdrawing heat from the environment, at a low temperature to form a gas and produce cooling. Often air or a heat transfer fluid flows over or around the evaporator to transfer the cooling effect caused by the evaporation of the refrigerant in the evaporator to a body to be cooled. The low-pressure gas enters a compressor where the gas is compressed to raise its pressure and temperature. The higher-pressure (compressed) gaseous refrigerant then enters the condenser in which the refrigerant condenses and discharges its heat to the environment. The refrigerant returns to the expansion device through which the liquid expands from the higher-pressure level in the condenser to the low-pressure level in the evaporator, thus repeating the cycle.

A body to be cooled or heated may be defined as any space, location, object or body for which it is desirable to provide cooling or heating. Examples include spaces (open or enclosed) requiring air conditioning, cooling, or heating, such as a room, an apartment, or building, such as an apartment building, university dormitory, townhouse, or other attached house or single family home, hospitals, office buildings, supermarkets, college or university classrooms or administration buildings and automobile or truck passenger compartments. Additionally, a body to be cooled may include electronic devices, such as computer equipment, central processing units (cpu), data-centers, server banks, and personal computers among others.

By “in the vicinity of” is meant that the evaporator of the system containing the refrigerant composition is located either within or adjacent to the body to be cooled, such that air moving over the evaporator would move into or around the body to be cooled. In the process for producing heating, “in the vicinity of” means that the condenser of the system containing the refrigerant composition is located either within or adjacent to the body to be heated, such that the air moving over the evaporator would move into or around the body to be heated. In some embodiments, for heat transfer, “in the vicinity of” may mean that the body to be cooled is immersed directly in the heat transfer composition or tubes containing heat transfer compositions run into around internally, and out of electronic equipment, for instance.

Exemplary refrigeration systems include, but are not limited to, equipment including commercial, industrial or residential refrigerators and freezers, ice machines, self-contained coolers and freezers, vending machines, flooded evaporator chillers, direct expansion chillers, water chiller, centrifugal chillers, walk-in and reach-in coolers and freezers, and combination systems. In some embodiments, the compositions provided herein may be used in supermarket refrigeration systems. Additionally, stationary applications may utilize a secondary loop system that uses a primary refrigerant to produce cooling in one location that is transferred to a remote location via a secondary heat transfer fluid.

In some embodiments, the compositions provided herein are useful in mobile heat transfer systems, including refrigeration, air conditioning, or heat pump systems or apparatus. In some embodiments, the compositions are useful in stationary heat transfer systems, including refrigeration, air conditioning, or heat pump systems or apparatus.

As used herein, mobile refrigeration, air conditioning, or heat pump systems refers to any refrigeration, air conditioner, or heat pump apparatus incorporated into a transportation unit for the road, rail, sea or air. Mobile air conditioning or heat pumps systems may be used in automobiles, trucks, railcars or other transportation systems. Mobile refrigeration may include transport refrigeration in trucks, airplanes, or rail cars. In addition, apparatus which are meant to provide refrigeration for a system independent of any moving carrier, known as “intermodal” systems, are including in the present inventions. Such intermodal systems include “containers” (combined sea/land transport) as well as “swap bodies” (combined road and rail transport).

As used herein, stationary air conditioning or heat pump systems are systems that are fixed in place during operation. A stationary air conditioning or heat pump system may be associated within or attached to buildings of any variety. These stationary applications may be stationary air conditioning and heat pumps, including but not limited to chillers, heat pumps, including residential and high temperature heat pumps, residential, commercial or industrial air conditioning systems, and including window, ductless, ducted, packaged terminal, and those exterior but connected to the building such as rooftop systems.

Stationary heat transfer may refer to systems for cooling electronic devices, such as immersion cooling systems, submersion cooling systems, phase change cooling systems, data-center cooling systems or simply liquid cooling systems.

In some embodiments, a method is provided for using the present compositions as a heat transfer fluid. The method comprises transporting said composition from a heat source to a heat sink.

In some embodiments, a method is provided for producing cooling comprising evaporating any of the present compounds or compositions in the vicinity of a body to be cooled, and thereafter condensing said composition.

In some embodiments, a method is provided for producing heating comprising condensing any of the present compositions in the vicinity of a body to be heated, and thereafter evaporating said compositions.

In some embodiments, the composition is for use in heat transfer, wherein the working fluid is a heat transfer component.

In some embodiments, the compositions of the invention are for use in refrigeration or air conditioning.

In some embodiments, the compositions of the invention are for use in a high temperature heat pump. In some embodiments, the high temperature heat pump is a centrifugal high temperature heat pump. In some embodiments, the high temperature heat pump comprises a condenser operating at a temperature greater than about 50° C. In some embodiments, the high temperature heat pump comprises a condenser operating at a temperature greater than about 100° C. In some embodiments, the high temperature heat pump comprises a condenser operating at a temperature greater than about 120° C. In some embodiments, the high temperature heat pump comprises a condenser operating at a temperature greater than about 150° C.

In some embodiments, a heat exchange system containing any the presently disclosed compositions is provided, wherein said system is selected from the group consisting of air conditioners, freezers, refrigerators, heat pumps, water chillers, flooded evaporator chillers, direct expansion chillers, walk-in coolers, heat pumps, mobile refrigerators, mobile air conditioning units, and systems having combinations thereof. Additionally, the compositions provided herein may be useful in secondary loop systems wherein these compositions serve as the primary refrigerant thus providing cooling to a secondary heat transfer fluid that thereby cools a remote location.

The compositions of the present invention may have some temperature glide in the heat exchangers. Thus, the systems may operate more efficiently if the heat exchangers are operated in counter-current mode or cross-current mode with counter-current tendency. Counter-current tendency means that the closer the heat exchanger can get to counter-current mode the more efficient the heat transfer. Thus, air conditioning heat exchangers, in particular evaporators, are designed to provide some aspect of counter-current tendency.

Therefore, provided herein is an air conditioning or heat pump system wherein said system includes one or more heat exchangers (either evaporators, condensers or both) that operate in counter-current mode or cross-current mode with counter-current tendency.

In some embodiments, provided herein is a refrigeration system wherein said system includes one or more heat exchangers (either evaporators, condensers or both) that operate in counter-current mode or cross-current mode with counter-current tendency.

In some embodiments, the refrigeration, air conditioning or heat pump system is a stationary refrigeration, air conditioning or heat pump system. In some embodiments the refrigeration, air conditioning, or heat pump system is a mobile refrigeration, air conditioning or heat pump system.

Additionally, in some embodiments, the disclosed compositions may function as primary refrigerants in secondary loop systems that provide cooling to remote locations by use of a secondary heat transfer fluid, which may comprise water, an aqueous salt solution (e.g., calcium chloride), a glycol, carbon dioxide, or a fluorinated hydrocarbon fluid (e.g., an HFC, HCFC, hydrofluoroolefin, hydrochlorofluoroolefin, chlorofluoroolefin, or perfluorocarbon). In this case, the secondary heat transfer fluid is the body to be cooled as it is adjacent to the evaporator and is cooled before moving to a second remote body to be cooled. In other embodiments, the disclosed compositions may function as the secondary heat transfer fluid, thus transferring or providing cooling (or heating) to the remote location.

In some embodiments, the compositions provided herein further comprise one or more non-refrigerant components (also referred to herein as additives) selected from the group consisting of lubricants, dyes (e.g., UV dyes), solubilizing agents, compatibilizers, stabilizers, tracers, perfluoropolyethers, anti-wear agents, extreme pressure agents, corrosion and oxidation inhibitors, metal surface energy reducers, metal surface deactivators, free radical scavengers, foam control agents, viscosity index improvers, pour point depressants, detergents, viscosity adjusters, and mixtures thereof. Indeed, many of these optional non-refrigerant components fit into one or more of these categories and may have qualities that lend themselves to achieve one or more performance characteristic.

In some embodiments, one or more non-refrigerant components are present in small amounts relative to the overall composition. In some embodiments, the one or more non-refrigerant components do not affect the azeotropic or azeotrope-like properties of the composition (i.e., the composition including the one or more non-refrigerant components is an azeotrope or azeotrope-like composition, as described herein). In some embodiments, the amount of additive(s) concentration in the disclosed compositions is from less than about 0.1 weight percent to as much as about 5 weight percent of the total composition. In some embodiments of the present invention, the additives are present in the disclosed compositions in an amount between about 0.1 weight percent to about 5 weight percent of the total composition or in an amount between about 0.1 weight percent to about 3.5 weight percent. The additive component(s) selected for the disclosed composition is selected on the basis of the utility and/or individual equipment components or the system requirements.

In some embodiments, the lubricant is selected from the group consisting of mineral oil, alkylbenzene, polyol esters, polyalkylene glycols, polyvinyl ethers, polycarbonates, perfluoropolyethers, silicones, silicate esters, phosphate esters, paraffins, naphthenes, polyalpha-olefins, and combinations thereof.

The lubricants as disclosed herein may be commercially available lubricants. For instance, the lubricant may be paraffinic mineral oil, sold by BVA Oils as BVM 100 N, naphthenic mineral oils sold by Crompton Co. under the trademarks Suniso® 1 GS, Suniso® 3GS and Suniso® 5GS, naphthenic mineral oil sold by Pennzoil under the trademark Sontex® 372LT, naphthenic mineral oil sold by Calumet Lubricants under the trademark Calumet® RO-30, linear alkylbenzenes sold by Shrieve Chemicals under the trademarks Zerol® 75, Zerol® 150 and Zerol® 500 and branched alkylbenzene sold by Nippon Oil as HAB 22, polyol esters (POEs) sold under the trademark Castrol® 100 by Castrol, United Kingdom, polyalkylene glycols (PAGs) such as RL-488A from Dow (Dow Chemical, Midland, Mich.), and mixtures thereof, meaning mixtures of any of the lubricants disclosed in this paragraph.

Notwithstanding the above weight ratios for compositions disclosed herein, it is understood that in some heat transfer systems, while the composition is being used, it may acquire additional lubricant from one or more equipment components of such heat transfer system. For example, in some refrigeration, air conditioning and heat pump systems, lubricants may be charged in the compressor and/or the compressor lubricant sump. Such lubricant would be in addition to any lubricant additive present in the refrigerant in such a system. In use, the refrigerant composition when in the compressor may pick up an amount of the equipment lubricant to change the refrigerant-lubricant composition from the starting ratio.

The non-refrigerant component used with the compositions of the present invention may include at least one dye. The dye may be at least one ultra-violet (UV) dye. As used herein, “ultra-violet” dye is defined as a UV fluorescent or phosphorescent composition that absorbs light in the ultra-violet or “near” ultra-violet region of the electromagnetic spectrum. The fluorescence produced by the UV fluorescent dye under illumination by a UV light that emits at least some radiation with a wavelength in the range of from 10 nanometers to about 775 nanometers may be detected.

UV dye is a useful component for detecting leaks of the composition by permitting one to observe the fluorescence of the dye at or in the vicinity of a leak point in an apparatus (e.g., refrigeration unit, air-conditioner or heat pump). The UV emission, e.g., fluorescence from the dye may be observed under an ultra-violet light. Therefore, if a composition containing such a UV dye is leaking from a given point in an apparatus, the fluorescence can be detected at the leak point, or in the vicinity of the leak point.

In some embodiments, the UV dye may be a fluorescent dye. In some embodiments, the fluorescent dye is selected from the group consisting of naphthalimides, perylenes, coumarins, anthracenes, phenanthracenes, xanthenes, thioxanthenes, naphthoxanthenes, fluoresceins, and derivatives of said dye, and combinations thereof, meaning mixtures of any of the foregoing dyes or their derivatives disclosed in this paragraph.

Another non-refrigerant component which may be used with the compositions of the present invention may include at least one solubilizing agent selected to improve the solubility of one or more dye in the disclosed compositions. In some embodiments, the weight ratio of dye to solubilizing agent ranges from about 99:1 to about 1:1. The solubilizing agents include at least one compound selected from the group consisting of hydrocarbons, hydrocarbon ethers, polyoxyalkylene glycol ethers (such as dipropylene glycol dimethyl ether), amides, nitriles, ketones, chlorocarbons (such as methylene chloride, trichloroethylene, chloroform, or mixtures thereof), esters, lactones, aromatic ethers, fluoroethers, and 1,1,1-trifluoroalkanes and mixtures thereof, meaning mixtures of any of the solubilizing agents disclosed in this paragraph.

In some embodiments, the non-refrigerant component comprises at least one compatibilizer to improve the compatibility of one or more lubricants with the disclosed compositions. The compatibilizer may be selected from the group consisting of hydrocarbons, hydrocarbon ethers, polyoxyalkylene glycol ethers (such as dipropylene glycol dimethyl ether), amides, nitriles, ketones, chlorocarbons (such as methylene chloride, trichloroethylene, chloroform, or mixtures thereof), esters, lactones, aromatic ethers, fluoroethers, 1,1,1-trifluoroalkanes, and mixtures thereof, meaning mixtures of any of the compatibilizers disclosed in this paragraph.

The solubilizing agent and/or compatibilizer may be selected from the group consisting of hydrocarbon ethers consisting of the ethers containing only carbon, hydrogen and oxygen, such as dimethyl ether (DME) and mixtures thereof, meaning mixtures of any of the hydrocarbon ethers disclosed in this paragraph.

The compatibilizer may be linear or cyclic aliphatic or aromatic hydrocarbon compatibilizer containing from 3 to 15 carbon atoms. The compatibilizer may be at least one hydrocarbon, which may be selected from the group consisting of at least propanes, including propylene and propane, butanes, including n-butane and isobutene, pentanes, including n-pentane, isopentane, neopentane and cyclopentane, hexanes, octanes, nonane, and decanes, among others. Commercially available hydrocarbon compatibilizers include but are not limited to those from Exxon Chemical (USA) sold under the trademarks Isopar® H, a mixture of undecane (C₁₁) and dodecane (C₁₂) (a high purity C₁₁ to C₁₂ iso-paraffinic), Aromatic 150 (a C₉ to C₁₁ aromatic) (Aromatic 200 (a C₉ to C₁₅ aromatic) and Naptha 140 (a mixture of C₅ to C₁₁ paraffins, naphthenes and aromatic hydrocarbons) and mixtures thereof, meaning mixtures of any of the hydrocarbons disclosed in this paragraph.

The compatibilizer may alternatively be at least one polymeric compatibilizer. The polymeric compatibilizer may be a random copolymer of fluorinated and non-fluorinated acrylates, wherein the polymer comprises repeating units of at least one monomer represented by the formulae CH₂═C(R¹)CO₂R², CH₂═C(R³)C₆H₄R⁴, and CH₂═C(R⁵)C₆H₄XR⁶, wherein X is oxygen or sulfur; R¹, R³, and R⁵ are independently selected from the group consisting of H and C₁-C₄ alkyl radicals; and R², R⁴, and R⁶ are independently selected from the group consisting of carbon-chain-based radicals containing C, and F, and may further contain H, Cl, ether oxygen, or sulfur in the form of thioether, sulfoxide, or sulfone groups and mixtures thereof. Examples of such polymeric compatibilizers include those commercially available from E. I. du Pont de Nemours and Company, (Wilmington, Del., 19898, USA) under the trademark Zonyl® PHS. Zonyl® PHS is a random copolymer made by polymerizing 40 weight percent CH₂═C(CH₃)CO₂CH₂CH₂(CF₂CF₂)ₘF (also referred to as Zonyl® fluoromethacrylate or ZFM) wherein m is from 1 to 12, primarily 2 to 8, and 60 weight percent lauryl methacrylate (CH₂═C(CH₃)CO₂(CH₂)₁₁CH₃, also referred to as LMA).

In some embodiments, the compatibilizer component contains from about 0.01 to 30 weight percent (based on total amount of compatibilizer) of an additive which reduces the surface energy of metallic copper, aluminum, steel, or other metals and metal alloys thereof found in heat exchangers in a way that reduces the adhesion of lubricants to the metal. Examples of metal surface energy reducing additives include those commercially available from DuPont under the trademarks Zonyl® FSA, Zonyl® FSP, and Zonyl® FSJ.

Another non-refrigerant component which may be used with the compositions of the present invention may be a metal surface deactivator. The metal surface deactivator is selected from the group consisting of areoxalyl bis (benzylidene) hydrazide (CAS reg no. 6629-10-3), N,N′-bis(3,5-di-tert-butyl-4-hydroxyhydrocinnamoylhydrazine (CAS reg no. 32687-78-8), 2,2,′-oxamidobis-ethyl-(3,5-di-tert-butyl-4-hydroxyhydrocinnamate (CAS reg no. 70331-94-1), N,N′-(disalicyclidene)-1,2-diaminopropane (CAS reg no. 94-91-7) and ethylenediaminetetra-acetic acid (CAS reg no. 60-00-4) and its salts, and mixtures thereof, meaning mixtures of any of the metal surface deactivators disclosed in this paragraph.

The non-refrigerant component used with the compositions of the present invention may alternatively be a stabilizer selected from the group consisting of hindered phenols, thiophosphates, butylated triphenylphosphorothionates, organo phosphates, or phosphites, aryl alkyl ethers, terpenes, terpenoids, epoxides, fluorinated epoxides, oxetanes, ascorbic acid, thiols, lactones, thioethers, amines, nitromethane, alkylsilanes, benzophenone derivatives, aryl sulfides, divinyl terephthalic acid, diphenyl terephthalic acid, hydrazones, such as acetaldehyde dimethylhydrazone, ionic liquids, and mixtures thereof. Terpene or terpenoid stabilizers may include farnesene. Phosphite stabilizers may include diphenyl phosphite.

The stabilizer may be selected from the group consisting of tocopherol; hydroquinone; t-butyl hydroquinone; monothiophosphates; and dithiophosphates, commercially available from Ciba Specialty Chemicals, Basel, Switzerland, hereinafter “Ciba”, under the trademark Irgalube® 63; dialkylthiophosphate esters, commercially available from Ciba under the trademarks Irgalube® 353 and Irgalube® 350, respectively; butylated triphenylphosphorothionates, commercially available from Ciba under the trademark Irgalube® 232; amine phosphates, commercially available from Ciba under the trademark Irgalube® 349 (Ciba); hindered phosphites, commercially available from Ciba as Irgafos® 168 and Tris-(di-tert-butylphenyl)phosphite, commercially available from Ciba under the trademark Irgafos® OPH; (Di-n-octyl phosphite); and iso-decyl diphenyl phosphite, commercially available from Ciba under the trademark Irgafos® DDPP; trialkyl phosphates, such as trimethyl phosphate, triethylphosphate, tributyl phosphate, trioctyl phosphate, and tri(2-ethylhexyl)phosphate; triaryl phosphates including triphenyl phosphate, tricresyl phosphate, and trixylenyl phosphate; and mixed alkyl-aryl phosphates including isopropylphenyl phosphate (IPPP), and bis(t-butylphenyl)phenyl phosphate (TBPP); butylated triphenyl phosphates, such as those commercially available under the trademark Syn-O-Ad®including Syn-O-Ad® 8784; tert-butylated triphenyl phosphates such as those commercially available under the trademark Durad®620; isopropylated triphenyl phosphates such as those commercially available under the trademarks Durad® 220 and Durad®110; anisole; 1,4-dimethoxybenzene; 1,4-diethoxybenzene; 1,3,5-trimethoxybenzene; myrcene, alloocimene, limonene (in particular, d-limonene); retinal; pinene; menthol; geraniol; farnesol; phytol; Vitamin A; terpinene; delta-3-carene; terpinolene; phellandrene; fenchene; dipentene; caratenoids, such as lycopene, beta carotene, and xanthophylls, such as zeaxanthin; retinoids, such as hepaxanthin and isotretinoin; bornane; 1,2-propylene oxide; 1,2-butylene oxide; n-butyl glycidyl ether; trifluoromethyloxirane; 1,1-bis(trifluoromethyl)oxirane; 3-ethyl-3-hydroxymethyl-oxetane, such as OXT-101 (Toagosei Co., Ltd); 3-ethyl-3-((phenoxy)methyl)-oxetane, such as OXT-211 (Toagosei Co., Ltd); 3-ethyl-3-((2-ethyl-hexyloxy)methyl)-oxetane, such as OXT-212 (Toagosei Co., Ltd); ascorbic acid; methanethiol (methyl mercaptan); ethanethiol (ethyl mercaptan); Coenzyme A; dimercaptosuccinic acid (DMSA); grapefruit mercaptan ((R)-2-(4-methylcyclohex-3-enyl)propane-2-thiol)); cysteine ((R)-2-amino-3-sulfanyl-propanoic acid); lipoamide (1,2-dithiolane-3-pentanamide); 5,7-bis(1,1-dimethylethyl)-3-[2,3(or 3,4)-dimethylphenyl]-2(3H)-benzofuranone, commercially available from Ciba under the trademark Irganox® HP-136; benzyl phenyl sulfide; diphenyl sulfide; diisopropylamine; dioctadecyl 3,3′-thiodipropionate, commercially available from Ciba under the trademark Irganox® PS 802 (Ciba); didodecyl 3,3′-thiopropionate, commercially available from Ciba under the trademark Irganox® PS 800; di-(2,2,6,6-tetramethyl-4-piperidyl)sebacate, commercially available from Ciba under the trademark Tinuvin® 770; poly-(N-hydroxyethyl-2,2,6,6-tetramethyl-4-hydroxy-piperidyl succinate, commercially available from Ciba under the trademark Tinuvin® 622LD (Ciba); methyl bis tallow amine; bis tallow amine; phenol-alpha-naphthylamine; bis(dimethylamino)methylsilane (DMAMS); tris(trimethylsilyl)silane (TTMSS); vinyltriethoxysilane; vinyltrimethoxysilane; 2,5-difluorobenzophenone; 2′,5′-dihydroxyacetophenone; 2-aminobenzophenone; 2-chlorobenzophenone; benzyl phenyl sulfide; diphenyl sulfide; dibenzyl sulfide; ionic liquids; and mixtures and combinations thereof.

The additive used with the compositions of the present invention may alternatively be an ionic liquid stabilizer. The ionic liquid stabilizer may be selected from the group consisting of organic salts that are liquid at room temperature (approximately 25° C.), those salts containing cations selected from the group consisting of pyridinium, pyridazinium, pyrimidinium, pyrazinium, imidazolium, pyrazolium, thiazolium, oxazolium and triazolium and mixtures thereof; and anions selected from the group consisting of [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, and F⁻, and mixtures thereof. In some embodiments, ionic liquid stabilizers are selected from the group consisting of emim BF₄ (1-ethyl-3-methylimidazolium tetrafluoroborate); bmim BF₄ (1-butyl-3-methylimidazolium tetraborate); emim PF₆ (1-ethyl-3-methylimidazolium hexafluorophosphate); and bmim PF₆ (1-butyl-3-methylimidazolium hexafluorophosphate), all of which are available from Fluka (Sigma-Aldrich).

In some embodiments, the stabilizer may be a hindered phenol, which is any substituted phenol compound, including phenols comprising one or more substituted or cyclic, straight chain, or branched aliphatic substituent group, such as, alkylated monophenols including 2,6-di-tert-butyl-4-methylphenol; 2,6-di-tert-butyl-4-ethylphenol; 2,4-dimethyl-6-tertbutylphenol; tocopherol; and the like, hydroquinone and alkylated hydroquinones including t-butyl hydroquinone, other derivatives of hydroquinone; and the like, hydroxylated thiodiphenyl ethers, including 4,4′-thio-bis(2-methyl-6-tert-butylphenol); 4,4′-thiobis(3-methyl-6-tertbutylphenol); 2,2′-thiobis(4methyl-6-tert-butylphenol); and the like, alkylidene-bisphenols including: 4,4′-methylenebis(2,6-di-tert-butylphenol); 4,4′-bis(2,6-di-tert-butylphenol); derivatives of 2,2′- or 4,4-biphenoldiols; 2,2′-methylenebis(4-ethyl-6-tertbutylphenol); 2,2′-methylenebis(4-methyl-6-tertbutylphenol); 4,4-butylidenebis(3-methyl-6-tert-butylphenol); 4,4-isopropylidenebis(2,6-di-tert-butylphenol); 2,2′-methylenebis(4-methyl-6-nonylphenol); 2,2′-isobutylidenebis(4,6-dimethylphenol; 2,2′-methylenebis(4-methyl-6-cyclohexylphenol, 2,2- or 4,4-biphenyldiols including 2,2′-methylenebis(4-ethyl-6-tert-butylphenol); butylated hydroxytoluene (BHT, or 2,6-di-tert-butyl-4-methylphenol), bisphenols comprising heteroatoms including 2,6-di-tert-alpha-dimethylamino-p-cresol, 4,4-thiobis(6-tert-butyl-m-cresol); and the like; acylaminophenols; 2,6-di-tert-butyl-4(N,N′-dimethylaminomethylphenol); sulfides including; bis(3-methyl-4-hydroxy-5-tert-butylbenzyl)sulfide; bis(3,5-di-tert-butyl-4-hydroxybenzyl)sulfide and mixtures thereof, meaning mixtures of any of the phenols disclosed in this paragraph.

The non-refrigerant component which is used with compositions of the present invention may alternatively be a tracer. The tracer may be two or more tracer compounds from the same class of compounds or from different classes of compounds. In some embodiments, the tracer is present in the compositions at a total concentration of about 50 parts per million by weight (ppm) to about 1000 ppm, based on the weight of the total composition. In other embodiments, the tracer is present at a total concentration of about 50 ppm to about 500 ppm. Alternatively, the tracer is present at a total concentration of about 100 ppm to about 300 ppm.

The tracer may be selected from the group consisting of hydrofluorocarbons (HFCs), deuterated hydrofluorocarbons, perfluorocarbons, fluoroethers, brominated compounds, iodinated compounds, aldehydes, and ketones, nitrous oxide and combinations thereof. Alternatively, the tracer may be selected from the group consisting of trifluoromethane (HFC-23), fluoroethane (HFC-161), 1,1,1,2,2,3,3-heptafluoropropane (HFC-227ca), 1,1,1,2,2,3-hexafluoropropane (HFC-236cb), 1,1,1,2,3,3-hexafluoropropane (HFC-236ea), 1,1,1,2,2-pentafluoropropane (HFC-245cb), 1,1,2,2-tetrafluoropropane (HFC-254cb), 1,1,1,2-tetrafluoropropane (HFC-254eb), 1,1,1-trifluoropropane (HFC-263fb), 2,2-difluoropropane (HFC-272ca), 2-fluoropropane (HFC-281ea), 1-fluoropropane (HFC-281fa), 1,1,1,2,2,3,3,4-nonafluorobutane (HFC-329p), 1,1,1-trifluoro-2-methylpropane (HFC-329mmz), 1,1,1,2,2,4,4,4-octafluorobutane (HFC-338mf), 1,1,2,2,3,3,4,4-octafluorobutane (HFC-338pcc), 1,1,1,2,2,3,3-heptafluorobutane (HFC-347s), hexafluoroethane (perfluoroethane, PFC-116), perfluoro-cyclopropane (PFC-C216), perfluoropropane (PFC-218), perfluoro-cyclobutane (PFC-C318), perfluorobutane (PFC-31-10mc), perfluoro-2-methylpropane (CF₃CF(CF₃)₂), perfluoro-1,3-dimethylcyclobutane (PFC-C51-12mycm), trans-perfluoro-2,3-dimethylcyclobutane (PFC-C51-12mym, trans), cis-perfluoro-2,3-dimethylcyclobutane (PFC-C51-12mym, cis), perfluoromethylcyclopentane, perfluoromethylcyclohexane, perfluorodimethylcyclohexane (ortho, meta, or para), perfluoroethylcyclohexane, perfluoroindan, perfluorotrimethylcyclohexane and isomers thereof, perfluoroisopropylcyclohexane, cis-perfluorodecalin, trans-perfluorodecalin, cis- or trans-perfluoromethyldecalin and mixtures thereof. In some embodiments, the tracer is a blend containing two or more hydrofluorocarbons, or one hydrofluorocarbon in combination with one or more perfluorocarbons.

The tracer may be added to the compositions of the present invention in predetermined quantities to allow detection of any dilution, contamination or other alteration of the composition.

The additive which may be used with the compositions of the present invention may alternatively be a perfluoropolyether as described in detail in US 2007-0284555, the disclosure of which is incorporated herein by reference in its entirety.

It will be recognized that certain of the additives referenced above as suitable for the non-refrigerant component have been identified as potential refrigerants. However, in accordance with this invention, when these additives are used, they are not present at an amount that would affect the novel and basic characteristics of the refrigerant mixtures of this invention.

In some embodiments, the refrigerant compositions disclosed herein may be prepared by any convenient method to combine the desired amounts of the individual components as is standard in the art. A preferred method is to weigh the desired component amounts and thereafter combine the components in an appropriate vessel. Agitation may be used, if desired.

### Example 1. E-HFO-1336mzz/Ethanol Compositions

The binary system of E-HFO-1336mzz/ethanol was explored for potential azeotropic and near-azeotropic behavior. To determine the relative volatility of this binary system, the PTx method described above was used. The pressure in a PTx cell of known volume was measured at constant temperature of 29.88 OC for various binary compositions. The collected experimental VLE data are displayed in Table 1 below.

TABLE 1

| Liquid mole | Vapor mole | | | |
|---|---|---|---|---|
| fraction of | fraction of | psia | Psia | ((p_{calc})/(pₑₓₚ)) − |
| E-HFO-1336mzz | E-HFO-1336mzz | (expt) | (calc) | 1 |
| 0 | 0 | 1.55 | | |
| 0.00424 | 0.47919 | 2.94 | 2.9769 | 1.25E−02 |
| 0.00876 | 0.6485 | 4.34 | 4.4108 | 1.63E−02 |
| 0.01833 | 0.78461 | 7.14 | 7.1914 | 7.20E−03 |
| 0.06572 | 0.91033 | 17.56 | 17.0904 | −2.67E−02 |
| 0.14494 | 0.9415 | 26.22 | 25.6199 | −2.29E−02 |
| 0.24663 | 0.95173 | 29.9 | 30.2647 | 1.22E−02 |
| 0.34984 | 0.95493 | 31.07 | 31.891 | 2.64E−02 |
| 0.44786 | 0.9554 | 31.51 | 32.1161 | 1.92E−02 |
| 0.54753 | 0.95454 | 31.79 | 31.8023 | 3.86E−04 |
| 0.64677 | 0.95322 | 32.07 | 31.4322 | −1.99E−02 |
| 0.75097 | 0.95294 | 32.42 | 31.3602 | −3.27E−02 |
| 0.84953 | 0.95726 | 32.84 | 31.8478 | −3.02E−02 |
| 0.93072 | 0.97059 | 33.38 | 32.7372 | −1.93E−02 |
| 0.98006 | 0.98876 | 33.68 | 33.4318 | −7.37E−03 |
| 0.99008 | 0.99405 | 33.7 | 33.5737 | −3.75E−03 |
| 0.99555 | 0.99724 | 33.7 | 33.6496 | −1.50E−03 |
| 1 | 1 | 33.71 | | |

Pₑₓₚ = experimentally measured pressure.
P_{calc} = pressure as calculated by NRTL model.

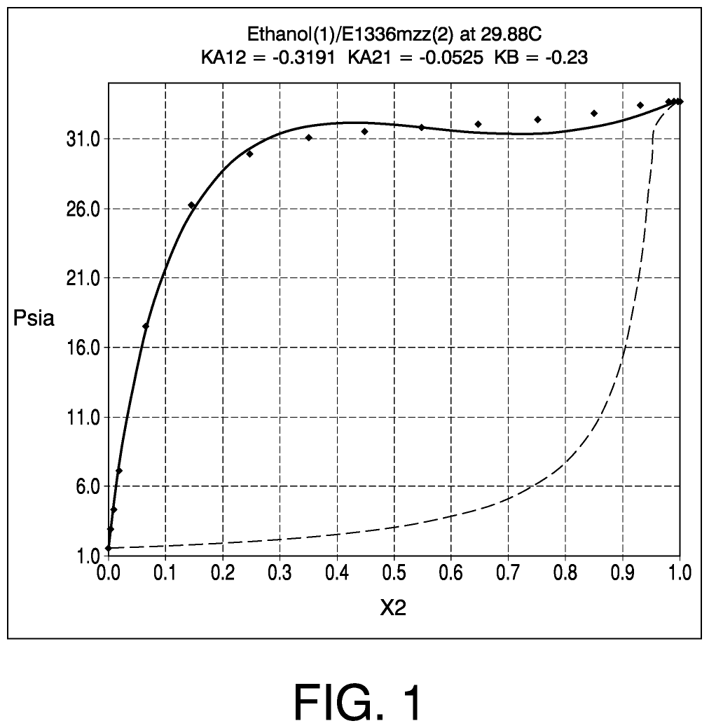

FIG. 1 displays a plot of the pressure vs composition data over the compositional range of 0-1 liquid mole fraction of E-HFO-1336mzz. The top curve represents the bubble point (“BP”) locus, and the bottom curve represents the dew point (“DP”) locus.

Based on these VLE data, interaction coefficients were extracted. The NRTL model was run over the temperature range of −40 to 120 QC in increments of 10 QC allowing pressure to vary such that the azeotropic condition (X₂=Y₍₂₎ was met. The resulting predictions of azeotropes in the F-HFO-1336mzz/ethanol system are displayed in Table 2.

TABLE 2

| | Azeotrope | E-HFO-1336mzz | |
|---|---|---|---|
| Temp | Pressure | Vapor | Ethanol Vapor |
| (° C.) | (psia) | (Mole fraction) | (Mole fraction) |
| −40 | No azeotrope formation | | |
| −30 | No azeotrope formation | | |
| −20 | No azeotrope formation | | |
| −10 | No azeotrope formation | | |
| 0 | No azeotrope formation | | |
| 10 | No azeotrope formation | | |
| 20 | No azeotrope formation | | |
| 29.88 | No azeotrope formation | | |
| 30 | No azeotrope formation | | |
| 40 | No azeotrope formation | | |
| 50 | No azeotrope formation | | |
| 60 | 83.4 | 0.9724 | 0.0275 |
| 70 | 109.2 | 0.9520 | 0.0479 |
| 80 | 141.5 | 0.9300 | 0.0700 |
| 90 | 1821 | 0.9063 | 0.0936 |
| 100 | 233.9 | 0.8806 | 0.1194 |
| 110 | 303.6 | 0.8492 | 0.1508 |
| 120 | 365.1 | 0.8203 | 0.1797 |

The NRTL model was used to predict azeotropes over a pressure range of 1-30 atm at 1 atm increments, the results of which are displayed in Table 3.

TABLE 3

| | Azeotrope | E-HFO-1336mzz | |
|---|---|---|---|
| Pressure | Temperature | Vapor | Ethanol Vapor |
| (atm) | (° C.) | (Mole fraction) | (Mole fraction) |
| 1 | No azeotropes formed | | |
| 2 | No azeotropes formed | | |
| 3 | No azeotropes formed | | |
| 4 | No azeotropes formed | | |
| 5 | No azeotropes formed | | |
| 6 | 62.0 | 0.9684 | 0.0316 |
| 7 | 67.7 | 0.9568 | 0.0432 |
| 8 | 72.8 | 0.9460 | 0.0540 |
| 9 | 77.4 | 0.9360 | 0.0640 |
| 10 | 81.5 | 0.9266 | 0.0734 |
| 11 | 85.3 | 0.9178 | 0.0822 |
| 12 | 88.7 | 0.9095 | 0.0905 |
| 13 | 91.9 | 0.9016 | 0.0984 |
| 14 | 94.9 | 0.8941 | 0.1059 |
| 15 | 97.6 | 0.8869 | 0.1131 |
| 16 | 100.2 | 0.8800 | 0.1200 |
| 17 | 102.6 | 0.8734 | 0.1266 |
| 18 | 104.8 | 0.8670 | 0.1330 |
| 19 | 106.8 | 0.8607 | 0.1393 |
| 20 | 108.6 | 0.8540 | 0.1460 |
| 21 | 110.8 | 0.8467 | 0.1533 |
| 22 | 113.3 | 0.8396 | 0.1604 |
| 23 | 115.7 | 0.8327 | 0.1673 |
| 24 | 118.1 | 0.8259 | 0.1741 |
| 25 | 120.4 | 0.8193 | 0.1807 |
| 26 | 122.6 | 0.8128 | 0.1872 |
| 27 | 124.8 | 0.8064 | 0.1936 |
| 28 | 127.0 | 0.8002 | 0.1998 |
| 29 | 129.1 | 0.7941 | 0.2059 |
| 30 | 131.1 | 0.7881 | 0.2119 |

The model was performed over a temperature range from −40 to 140° C. in 20° C. increments, and also at 29.88° C. for comparison to experimentally measured results. At each temperature, the model was performed over the full range from 0 to 1 of E-HFO-1336mzz liquid molar composition (in increments of 0.002). Thus the model was performed at a total of 5010 combinations of temperature and E-HFO-1336mzz liquid molar composition (10 temperatures×501 compositions=5010). Table 4 shows increments of 0.10 E-HFO-1336mzz liquid molar composition, or the boundaries of near-azeotropic behavior.

TABLE 4

| | Liquid | Vapor | Liquid | Vapor | Bubble | Dew | |
|---|---|---|---|---|---|---|---|
| | E-1336mzz | E-1336mzz | Ethanol | Ethanol | Point | Point | |
| Temp | (Mole | (Mole | (Mole | (Mole | Pressure | Pressure | (BP − DP)/ |
| (° C.) | Fraction) | Fraction) | Fraction) | Fraction) | (psia) | (psia) | BP × 100% |
| −40 | 0.994 | 0.999 | 0.006 | 0.001 | 1.346 | 1.234 | 8.32% |
| −40 | 0.996 | 0.999 | 0.004 | 0.001 | 1.348 | 1.321 | 1.99% |
| −40 | 0.998 | 1.000 | 0.002 | 0.000 | 1.350 | 1.338 | 0.84% |
| −40 | 1.000 | 1.000 | 0.000 | 0.000 | 1.352 | 1.352 | 0.00% |
| −20.0 | 0.988 | 0.997 | 0.012 | 0.003 | 4.169 | 3.790 | 9.08% |
| −20.0 | 0.990 | 0.997 | 0.010 | 0.003 | 4.174 | 4.047 | 3.03% |
| −20.0 | 0.992 | 0.998 | 0.008 | 0.002 | 4.180 | 4.092 | 2.09% |
| −20.0 | 0.998 | 0.999 | 0.002 | 0.001 | 4.197 | 4.181 | 0.38% |
| −20.0 | 1 | 1 | 0 | 0 | 4.203 | 4.203 | 0.00% |
| 0.0 | 0.978 | 0.992 | 0.022 | 0.008 | 10.626 | 9.625 | 9.41% |
| 0.0 | 0.980 | 0.993 | 0.020 | 0.007 | 10.637 | 10.233 | 3.79% |
| 0.0 | 0.982 | 0.993 | 0.018 | 0.007 | 10.648 | 10.337 | 2.93% |
| 0.0 | 1.000 | 1.000 | 0.000 | 0.000 | 10.755 | 10.755 | 0.00% |
| 20.0 | 0.964 | 0.983 | 0.036 | 0.017 | 23.354 | 21.770 | 6.78% |
| 20.0 | 0.966 | 0.984 | 0.034 | 0.016 | 23.373 | 22.493 | 3.77% |
| 20.0 | 0.968 | 0.984 | 0.032 | 0.016 | 23.392 | 22.677 | 3.06% |
| 20.0 | 0.970 | 0.985 | 0.030 | 0.015 | 23.411 | 22.817 | 2.54% |
| 20.0 | 1.000 | 1.000 | 0.000 | 0.000 | 23.689 | 23.689 | 0.00% |
| 29.88 | 0.954 | 0.976 | 0.046 | 0.024 | 32.980 | 30.576 | 7.29% |
| 29.88 | 0.956 | 0.976 | 0.044 | 0.024 | 33.002 | 31.540 | 4.43% |
| 29.88 | 0.958 | 0.977 | 0.042 | 0.023 | 33.025 | 31.935 | 3.30% |
| 29.88 | 0.960 | 0.978 | 0.040 | 0.022 | 33.048 | 32.138 | 2.75% |
| 29.88 | 1.000 | 1.000 | 0.000 | 0.000 | 33.459 | 33.459 | 0.00% |
| 40.0 | 0.944 | 0.967 | 0.056 | 0.033 | 45.851 | 43.453 | 5.23% |
| 40.0 | 0.946 | 0.968 | 0.054 | 0.032 | 45.877 | 44.237 | 3.58% |
| 40.0 | 0.948 | 0.969 | 0.052 | 0.031 | 45.903 | 44.548 | 2.95% |
| 40.0 | 1.000 | 1.000 | 0.000 | 0.000 | 46.432 | 46.432 | 0.00% |
| 60.0 | 0.916 | 0.943 | 0.084 | 0.057 | 82.757 | 78.543 | 5.09% |
| 60.0 | 0.918 | 0.943 | 0.082 | 0.057 | 82.791 | 79.637 | 3.81% |
| 60.0 | 0.920 | 0.944 | 0.080 | 0.056 | 82.823 | 80.299 | 3.05% |
| 60.0 | 0.922 | 0.945 | 0.078 | 0.055 | 82.856 | 80.738 | 2.56% |
| 60.0 | 1.000 | 1.000 | 0.000 | 0.000 | 83.063 | 83.063 | 0.00% |
| 80.0 | 0.880 | 0.909 | 0.120 | 0.091 | 140.902 | 133.531 | 5.23% |
| 80.0 | 0.882 | 0.910 | 0.118 | 0.090 | 140.942 | 134.969 | 4.24% |
| 80.0 | 0.884 | 0.910 | 0.116 | 0.090 | 140.982 | 136.165 | 3.42% |
| 80.0 | 0.886 | 0.911 | 0.114 | 0.089 | 141.021 | 137.062 | 2.81% |
| 80.0 | 1.000 | 1.000 | 0.000 | 0.000 | 138.297 | 138.297 | 0.00% |
| 100.0 | 0.836 | 0.866 | 0.164 | 0.134 | 233.202 | 219.807 | 5.74% |
| 100.0 | 0.838 | 0.866 | 0.162 | 0.134 | 233.256 | 221.887 | 4.87% |
| 100.0 | 0.840 | 0.867 | 0.160 | 0.133 | 233.308 | 223.778 | 4.08% |
| 100.0 | 0.842 | 0.868 | 0.158 | 0.132 | 233.358 | 225.427 | 3.40% |
| 100.0 | 0.844 | 0.868 | 0.156 | 0.132 | 233.407 | 226.813 | 2.83% |
| 100.0 | 1.000 | 1.000 | 0.000 | 0.000 | 217.621 | 217.621 | 0.00% |
| 120.0 | 0.000 | 0.000 | 1.000 | 1.000 | 62.075 | 62.075 | 0.00% |
| 120.0 | 0.002 | 0.049 | 0.998 | 0.951 | 65.392 | 62.205 | 4.87% |
| 120.0 | 0.004 | 0.092 | 0.996 | 0.908 | 68.678 | 62.335 | 9.24% |
| 120.0 | 0.774 | 0.809 | 0.226 | 0.191 | 363.702 | 344.259 | 5.35% |
| 120.0 | 0.776 | 0.810 | 0.224 | 0.190 | 363.769 | 346.220 | 4.82% |
| 120.0 | 0.778 | 0.810 | 0.222 | 0.190 | 363.835 | 348.108 | 4.32% |
| 120.0 | 0.780 | 0.810 | 0.220 | 0.190 | 363.901 | 349.912 | 3.84% |
| 120.0 | 0.782 | 0.811 | 0.218 | 0.189 | 363.967 | 351.622 | 3.39% |
| 120.0 | 0.784 | 0.811 | 0.216 | 0.189 | 364.032 | 353.224 | 2.97% |
| 120.0 | 1.000 | 1.000 | 0.000 | 0.000 | 327.634 | 327.634 | 0.00% |
| 140.0 | 0.000 | 0.000 | 1.000 | 1.000 | 109.382 | 109.382 | 0.00% |
| 140.0 | 0.002 | 0.032 | 0.998 | 0.968 | 113.306 | 109.617 | 3.26% |
| 140.0 | 0.004 | 0.062 | 0.996 | 0.938 | 117.206 | 109.853 | 6.27% |
| 140.0 | 0.716 | 0.753 | 0.284 | 0.247 | 507.323 | 481.075 | 5.17% |
| 140.0 | 0.718 | 0.754 | 0.282 | 0.246 | 507.422 | 483.187 | 4.78% |
| 140.0 | 0.720 | 0.754 | 0.280 | 0.246 | 507.521 | 485.252 | 4.39% |
| 140.0 | 0.722 | 0.754 | 0.278 | 0.246 | 507.618 | 487.264 | 4.01% |
| 140.0 | 0.724 | 0.755 | 0.276 | 0.245 | 507.716 | 489.216 | 3.64% |
| 140.0 | 0.726 | 0.755 | 0.274 | 0.245 | 507.812 | 491.099 | 3.29% |
| 140.0 | 0.728 | 0.755 | 0.272 | 0.245 | 507.908 | 492.904 | 2.95% |
| 140.0 | 1.000 | 1.000 | 0.000 | 0.000 | | | |

Near-azeotropes formed between E-1336mzz and ethanol at 1 atm are shown in Table 5.

TABLE 5

| | | | | | | Bubble | Dew | |
|---|---|---|---|---|---|---|---|---|
| TOTAL | TOTAL | LIQUID | VAPOR | LIQUID | VAPOR | Point | Point | |
| PRES | TEMP | MOLEFRAC | MOLEFRAC | MOLEFRAC | MOLEFRAC | Pressure | Pressure | (BP − DP)/ |
| ATM | C. | E-1336mzz | E-1336mzz | EtOH | EtOH | (psia) | (psia) | BP × 100% |
| 1.00 | 7.83 | 0.974 | 0.989 | 0.026 | 0.011 | 14.696 | 13.814 | 6.00% |
| 1.00 | 7.81 | 0.976 | 0.990 | 0.024 | 0.010 | 14.696 | 14.190 | 3.44% |
| 1.00 | 7.78 | 0.978 | 0.991 | 0.022 | 0.009 | 14.696 | 14.290 | 2.76% |
| 1.00 | 7.76 | 0.980 | 0.991 | 0.020 | 0.009 | 14.696 | 14.367 | 2.24% |
| 1.00 | 7.74 | 0.982 | 0.992 | 0.018 | 0.008 | 14.696 | 14.428 | 1.82% |
| 1.00 | 7.71 | 0.984 | 0.993 | 0.016 | 0.007 | 14.696 | 14.480 | 1.47% |
| 1.00 | 7.69 | 0.986 | 0.994 | 0.014 | 0.006 | 14.696 | 14.524 | 1.17% |
| 1.00 | 7.66 | 0.988 | 0.994 | 0.012 | 0.006 | 14.696 | 14.561 | 0.92% |
| 1.00 | 7.64 | 0.990 | 0.995 | 0.010 | 0.005 | 14.696 | 14.593 | 0.70% |
| 1.00 | 7.61 | 0.992 | 0.996 | 0.008 | 0.004 | 14.696 | 14.620 | 0.51% |
| 1.00 | 7.59 | 0.994 | 0.997 | 0.006 | 0.003 | 14.696 | 14.644 | 0.35% |
| 1.00 | 7.56 | 0.996 | 0.998 | 0.004 | 0.002 | 14.696 | 14.664 | 0.22% |
| 1.00 | 7.54 | 0.998 | 0.999 | 0.002 | 0.001 | 14.696 | 14.681 | 0.10% |
| 1.00 | 7.51 | 1.000 | 1.000 | 0.000 | 0.000 | 14.696 | 14.696 | 0.00% |

The detailed data in Tables 4 and 5 are summarized in Table 6. From the results in Table 5, azeotrope-like compositions with differences of 3% or less between bubble point pressures and dew point pressures exist from 97.8 to 99.8 mole percent E-HFO-1336mzz and from 0.2 to 2.2 mole percent ethanol at 1 atmosphere pressure boiling at from 7.51 to 7.83° C. The broad ranges of 3% azeotrope-like compositions (based on [(BP−VP)/BP]×100≤3) are listed in Table 6.

TABLE 6

| | | E-HFO-1336mzz Vapor |
|---|---|---|
| | Temp | Mole Percentage |
| Components | (° C.) | (Remainder ethanol) |
| E-HFO-1336mzz/ethanol | −40 | 0.996-0.999 |
| E-HFO-1336mzz/ethanol | −20 | 0.992-0.999 |
| E-HFO-1336mzz/ethanol | 0 | 0.982-0.999 |
| E-HFO-1336mzz/ethanol | 20 | 0.968-0.999 |
| E-HFO-1336mzz/ethanol | 29.88 | 0.960-0.999 |
| E-HFO-1336mzz/ethanol | 40 | 0.948-0.999 |
| E-HFO-1336mzz/ethanol | 60 | 0.922-0.999 |
| E-HFO-1336mzz/ethanol | 80 | 0.886-0.999 |
| E-HFO-1336mzz/ethanol | 100 | 0.844-0.999 |
| E-HFO-1336mzz/ethanol | 120 | 0.784-0.999 |
| E-HFO-1336mzz/ethanol | 140 | 0.728-0.999 |

### Example 2. E-HFO-1336mzz/Isopropyl Alcohol Compositions

The binary system of E-HFO-1336mzz/isopropyl alcohol (i.e., isopropanol) was explored for potential azeotropic and near-azeotropic behavior. To determine the relative volatility of this binary system, the PTx method described above was used. The pressure in a PTx cell of known volume was measured at constant temperature of 29.99° C. for various binary compositions. The collected VLE experimental data are displayed in Table 7 below.

TABLE 7

| Liquid mole | Vapor mole | | | |
|---|---|---|---|---|
| fraction of | fraction of | psia | psia | ((p_{calc})/(pₑₓₚ)) − |
| E-HFO-1336mzz | E-HFO-1336mzz | (expt) | (calc) | 1 |
| 0 | 0 | 1.13 | | |
| 0.00455 | 0.56454 | 2.56 | 2.6146 | 2.13E−02 |
| 0.00923 | 0.71862 | 4 | 4.0489 | 1.22E−02 |
| 0.01911 | 0.83284 | 6.84 | 6.8179 | −3.24E−03 |
| 0.07023 | 0.93299 | 17.37 | 16.9075 | −2.66E−02 |
| 0.1561 | 0.95554 | 25.39 | 25.0131 | −1.48E−02 |
| 0.26393 | 0.96237 | 28.54 | 28.9108 | 1.30E−02 |
| 0.36859 | 0.96452 | 29.67 | 30.2166 | 1.84E−02 |
| 0.4707 | 0.96514 | 30.19 | 30.5599 | 1.23E−02 |
| 0.56955 | 0.96516 | 30.59 | 30.5724 | −5.75E−04 |
| 0.66823 | 0.96524 | 31.04 | 30.5974 | −1.43E−02 |
| 0.76566 | 0.96644 | 31.6 | 30.8868 | −2.26E−02 |
| 0.85953 | 0.97096 | 32.34 | 31.6345 | −2.18E−02 |
| 0.93442 | 0.98069 | 33.18 | 32.6906 | −1.47E−02 |
| 0.98186 | 0.99307 | 33.82 | 33.5902 | −6.80E−03 |
| 0.9907 | 0.99626 | 33.84 | 33.7749 | −1.93E−03 |
| 0.99558 | 0.99817 | 33.84 | 33.8785 | 1.14E−03 |
| 1 | 1 | 33.84 | | |

X₂ = liquid mole fraction of E-HFO-1336mzz.
Y₂ = vapor mole fraction of E-HFO-1336mzz.
Pₑₓₚ = experimentally measured pressure.
P_{calc} = pressure as calculated by NRTL model.

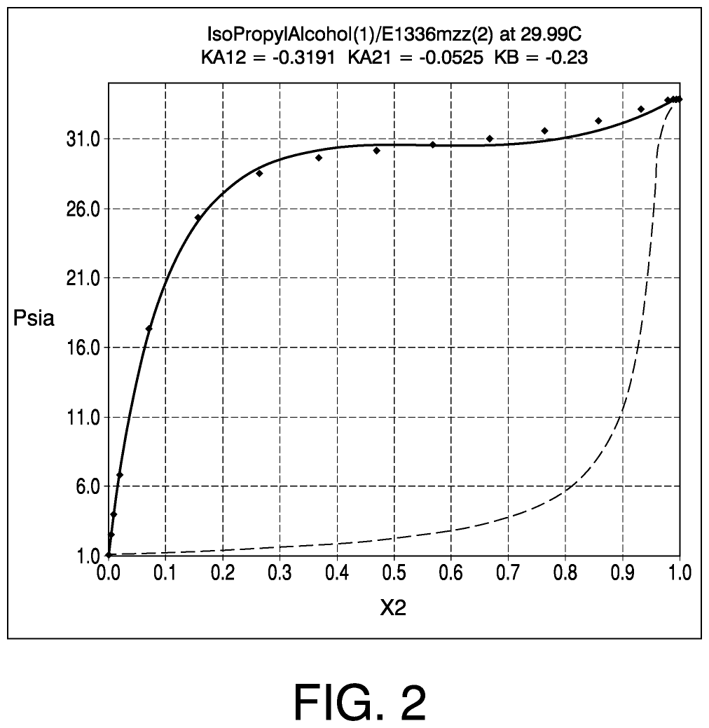

The vapor pressure vs. E-HFO-1336mzz liquid mole fraction data provided in Table 7 are also plotted in FIG. 2. The experimental data points are shown in FIG. 2 as solid points. The solid line represents bubble point predictions using the NRTL equation. The dashed line represents predicted dew points.

Based on these VLE data, interaction coefficients were extracted. The NRTL model was performed over the temperature range of −40 to 120° C. in increments of 10° C., allowing pressure to vary such that the azeotropic condition (X₂═Y₂) was met. The resulting predicted azeotropes in the E-HFO-1336mzz/isopropyl alcohol, and the experimentally determined data at 29.99° C., are displayed in Table 8.

TABLE 8

| | Azeotrope | E-HFO-1336mzz | Isopropanol |
|---|---|---|---|
| Temp | Pressure | Vapor | Vapor |
| (° C.) | (psia) | (mole fraction) | (mole fraction) |
| −40 | No azeotrope formation | | |
| −30 | No azeotrope formation | | |
| −20 | No azeotrope formation | | |
| −10 | No azeotrope formation | | |
| 0 | No azeotrope formation | | |
| 10 | No azeotrope formation | | |
| 20 | No azeotrope formation | | |
| 29.99 | No azeotrope formation | | |
| 30 | No azeotrope formation | | |
| 40 | No azeotrope formation | | |
| 50 | No azeotrope formation | | |
| 60 | No azeotrope formation | | |
| 70 | No azeotrope formation | | |
| 80 | 139.1 | 0.964 | 0.036 |
| 90 | 177.7 | 0.936 | 0.064 |
| 100 | 226.9 | 0.904 | 0.096 |
| 110 | 292.9 | 0.861 | 0.139 |
| 120 | 349.5 | 0.826 | 0.174 |

The model was further used to predict azeotropes over a pressure range of 1-20 atm at 1 atm increments, the results of which are displayed in Table 9.

TABLE 9

| | Azeotrope | E-HFO-1336mzz | Isopropanol |
|---|---|---|---|
| Pressure | Temperature | Vapor | Vapor |
| (atm) | (° C.) | (mole fraction) | (mole fraction) |
| 1 | No azeotrope formed | | |
| 2 | No azeotrope formed | | |
| 3 | No azeotrope formed | | |
| 4 | No azeotrope formed | | |
| 5 | No azeotrope formed | | |
| 6 | No azeotrope formed | | |
| 7 | 68.1 | 0.994 | 0.006 |
| 8 | 73.3 | 0.982 | 0.018 |
| 9 | 78.0 | 0.970 | 0.030 |
| 10 | 82.2 | 0.958 | 0.042 |
| 11 | 86.1 | 0.948 | 0.052 |
| 12 | 89.7 | 0.938 | 0.062 |
| 13 | 93.0 | 0.928 | 0.072 |
| 14 | 96.0 | 0.918 | 0.082 |
| 15 | 98.8 | 0.908 | 0.092 |
| 16 | 101.4 | 0.900 | 0.100 |
| 17 | 103.8 | 0.890 | 0.110 |
| 18 | 106.1 | 0.882 | 0.118 |
| 19 | 108.1 | 0.872 | 0.128 |

| | |
|---|---|
| 20 | No azeotrope formed |

The model was performed over a temperature range from −40 to 120° C. in 20° C. increments, and also at 29.99° C. for the purpose of comparison to experimentally measured results. At each temperature, the model was performed over the full range from 0 to 1 of E-HFO-1336mzz liquid molar composition (in increments of 0.002). Thus, the model was performed at a total of 4509 combinations of temperature and E-HFO-1336mzz liquid molar composition (9 temperatures×501 compositions=4509). Table 10 shows increments of 0.10 E-HFO-1336mzz liquid molar composition, or the boundaries of near-azeotropic behavior.

TABLE 10

| | Liquid | Vapor | Liquid | Vapor | Bubble | Dew | |
|---|---|---|---|---|---|---|---|
| | E-1336mzz | E-1336mzz | Isopropanol | Isopropanol | Point | Point | |
| Temp | (Mole | (Mole | (Mole | (Mole | Pressure | Pressure | (BP − DP)/ |
| (° C.) | Fraction) | Fraction) | Fraction) | Fraction) | (psia) | (psia) | BP × 100% |
| −40.0 | 0.996 | 1.000 | 0.004 | 0.000 | 1.347 | 1.040 | 22.79% |
| −40.0 | 0.998 | 1.000 | 0.002 | 0.000 | 1.350 | 1.313 | 2.74% |
| −40.0 | 1.000 | 1.000 | 0.000 | 0.000 | 1.352 | 1.352 | 0.00% |
| −20.0 | 0.992 | 0.999 | 0.008 | 0.001 | 4.175 | 3.643 | 12.74% |
| −20.0 | 0.994 | 0.999 | 0.006 | 0.001 | 4.182 | 3.999 | 4.37% |
| −20.0 | 0.996 | 0.999 | 0.004 | 0.001 | 4.189 | 4.086 | 2.46% |
| −20.0 | 0.998 | 1.000 | 0.002 | 0.000 | 4.196 | 4.150 | 1.09% |
| −20.0 | 1.000 | 1.000 | 0.000 | 0.000 | 4.203 | 4.203 | 0.00% |
| 0.0 | 0.986 | 0.997 | 0.014 | 0.003 | 10.645 | 10.008 | 5.98% |
| 0.0 | 0.988 | 0.997 | 0.012 | 0.003 | 10.660 | 10.192 | 4.39% |
| 0.0 | 0.990 | 0.998 | 0.010 | 0.002 | 10.675 | 10.327 | 3.26% |
| 0.0 | 0.992 | 0.998 | 0.008 | 0.002 | 10.691 | 10.438 | 2.37% |
| 0.0 | 0.998 | 0.999 | 0.002 | 0.001 | 10.739 | 10.688 | 0.47% |
| 0.0 | 1.000 | 1.000 | 0.000 | 0.000 | 10.755 | 10.755 | 0.00% |
| 20.0 | 0.976 | 0.992 | 0.024 | 0.008 | 23.348 | 22.176 | 5.02% |
| 20.0 | 0.978 | 0.992 | 0.022 | 0.008 | 23.375 | 22.405 | 4.15% |
| 20.0 | 0.980 | 0.993 | 0.020 | 0.007 | 23.403 | 22.595 | 3.45% |
| 20.0 | 0.982 | 0.994 | 0.018 | 0.006 | 23.430 | 22.759 | 2.86% |
| 20.0 | 0.998 | 0.999 | 0.002 | 0.001 | 23.659 | 23.615 | 0.19% |
| 20.0 | 1.000 | 1.000 | 0.000 | 0.000 | 23.689 | 23.689 | 0.00% |
| 29.88 | 0.968 | 0.987 | 0.032 | 0.013 | 32.899 | 31.232 | 5.07% |
| 29.88 | 0.970 | 0.988 | 0.030 | 0.012 | 32.933 | 31.516 | 4.30% |
| 29.88 | 0.972 | 0.988 | 0.028 | 0.012 | 32.967 | 31.754 | 3.68% |
| 29.88 | 0.974 | 0.989 | 0.026 | 0.011 | 33.001 | 31.961 | 3.15% |
| 29.88 | 0.976 | 0.990 | 0.024 | 0.010 | 33.036 | 32.145 | 2.70% |
| 29.88 | 0.998 | 0.999 | 0.002 | 0.001 | 33.423 | 33.387 | 0.11% |
| 29.88 | 1.000 | 1.000 | 0.000 | 0.000 | 33.459 | 33.459 | 0.00% |
| 40.0 | 0.958 | 0.980 | 0.042 | 0.020 | 45.579 | 43.285 | 5.03% |
| 40.0 | 0.960 | 0.981 | 0.040 | 0.019 | 45.619 | 43.634 | 4.35% |
| 40.0 | 0.962 | 0.982 | 0.038 | 0.018 | 45.660 | 43.931 | 3.79% |
| 40.0 | 0.964 | 0.983 | 0.036 | 0.017 | 45.701 | 44.190 | 3.31% |
| 40.0 | 0.966 | 0.983 | 0.034 | 0.017 | 45.742 | 44.420 | 2.89% |
| 40.0 | 0.998 | 0.999 | 0.002 | 0.001 | 46.393 | 46.368 | 0.05% |
| 40.0 | 1.000 | 1.000 | 0.000 | 0.000 | 46.432 | 46.432 | 0.00% |
| 60.0 | 0.930 | 0.959 | 0.070 | 0.041 | 81.579 | 77.064 | 5.53% |
| 60.0 | 0.932 | 0.960 | 0.068 | 0.040 | 81.631 | 77.693 | 4.82% |
| 60.0 | 0.934 | 0.961 | 0.066 | 0.039 | 81.684 | 78.216 | 4.25% |
| 60.0 | 0.936 | 0.962 | 0.064 | 0.038 | 81.737 | 78.665 | 3.76% |
| 60.0 | 0.938 | 0.962 | 0.062 | 0.038 | 81.789 | 79.061 | 3.34% |
| 60.0 | 0.940 | 0.963 | 0.060 | 0.037 | 81.841 | 79.413 | 2.97% |
| 60.0 | 0.998 | 0.998 | 0.002 | 0.002 | 83.043 | 83.041 | 0.00% |
| 60.0 | 1.000 | 1.000 | 0.000 | 0.000 | 83.063 | 83.063 | 0.00% |
| 80.0 | 0.894 | 0.927 | 0.106 | 0.073 | 137.618 | 130.197 | 5.39% |
| 80.0 | 0.896 | 0.928 | 0.104 | 0.072 | 137.682 | 131.156 | 4.74% |
| 80.0 | 0.898 | 0.929 | 0.102 | 0.071 | 137.745 | 131.978 | 4.19% |
| 80.0 | 0.900 | 0.929 | 0.100 | 0.071 | 137.808 | 132.692 | 3.71% |
| 80.0 | 0.902 | 0.930 | 0.098 | 0.070 | 137.869 | 133.322 | 3.30% |
| 80.0 | 0.904 | 0.931 | 0.096 | 0.069 | 137.931 | 133.883 | 2.93% |
| 80.0 | 0.998 | 0.998 | 0.002 | 0.002 | 138.391 | 138.373 | 0.01% |
| 80.0 | 1.000 | 1.000 | 0.000 | 0.000 | 138.297 | 138.297 | 0.00% |
| 100.0 | 0.848 | 0.881 | 0.152 | 0.119 | 225.596 | 214.280 | 5.02% |
| 100.0 | 0.850 | 0.881 | 0.150 | 0.119 | 225.673 | 215.704 | 4.42% |
| 100.0 | 0.852 | 0.882 | 0.148 | 0.118 | 225.749 | 216.967 | 3.89% |
| 100.0 | 0.854 | 0.883 | 0.146 | 0.117 | 225.823 | 218.087 | 3.43% |
| 100.0 | 0.856 | 0.883 | 0.144 | 0.117 | 225.895 | 219.085 | 3.01% |
| 100.0 | 0.858 | 0.884 | 0.142 | 0.116 | 225.966 | 219.977 | 2.65% |
| 100.0 | 0.998 | 0.997 | 0.002 | 0.003 | 218.113 | 217.914 | 0.09% |
| 100.0 | 1.000 | 1.000 | 0.000 | 0.000 | 217.621 | 217.621 | 0.00% |
| 120.0 | 0.774 | 0.811 | 0.226 | 0.189 | 346.805 | 329.220 | 5.07% |
| 120.0 | 0.776 | 0.811 | 0.224 | 0.189 | 346.913 | 330.845 | 4.63% |
| 120.0 | 0.778 | 0.812 | 0.222 | 0.188 | 347.021 | 332.384 | 4.22% |
| 120.0 | 0.780 | 0.812 | 0.220 | 0.188 | 347.129 | 333.833 | 3.83% |
| 120.0 | 0.782 | 0.813 | 0.218 | 0.187 | 347.236 | 335.190 | 3.47% |
| 120.0 | 0.784 | 0.813 | 0.216 | 0.187 | 347.344 | 336.455 | 3.13% |
| 120.0 | 0.786 | 0.814 | 0.214 | 0.186 | 347.451 | 337.632 | 2.83% |
| 120.0 | 0.998 | 0.995 | 0.002 | 0.005 | 329.574 | 328.487 | 0.33% |
| 120.0 | 1.000 | 1.000 | 0.000 | 0.000 | 327.634 | 327.634 | 0.00% |

Near-azeotropes formed between E-1336mzz and isopropyl alcohol at 1 atm are shown in Table 11. Increments of 0.10 E-HFO-1336mzz liquid molar composition, or the boundaries of near-azeotropic behavior, are shown.

TABLE 11

| | Liquid | Vapor | Liquid | Vapor | Bubble | Dew | |
|---|---|---|---|---|---|---|---|
| | E-1336mzz | E-1336mzz | Isopropanol | Isopropanol | Point | Point | |
| Temp | (Mole | (Mole | (Mole | (Mole | Pressure | Pressure | (BP − DP)/ |
| (° C.) | Fraction) | Fraction) | Fraction) | Fraction) | (psia) | (psia) | BP × 100% |
| 7.82 | 0.982 | 0.995 | 0.018 | 0.005 | 14.696 | 13.803 | 6.07% |
| 7.79 | 0.984 | 0.996 | 0.016 | 0.004 | 14.696 | 14.007 | 4.69% |
| 7.75 | 0.986 | 0.996 | 0.014 | 0.004 | 14.696 | 14.154 | 3.69% |
| 7.72 | 0.988 | 0.997 | 0.012 | 0.003 | 14.696 | 14.272 | 2.89% |
| 7.69 | 0.990 | 0.997 | 0.010 | 0.003 | 14.696 | 14.370 | 2.22% |
| 7.65 | 0.992 | 0.998 | 0.008 | 0.002 | 14.696 | 14.454 | 1.65% |
| 7.62 | 0.994 | 0.998 | 0.006 | 0.002 | 14.696 | 14.527 | 1.15% |
| 7.58 | 0.996 | 0.999 | 0.004 | 0.001 | 14.696 | 14.591 | 0.72% |
| 7.55 | 0.998 | 0.999 | 0.002 | 0.001 | 14.696 | 14.647 | 0.34% |
| 7.51 | 1.000 | 1.000 | 0.000 | 0.000 | 14.696 | 14.696 | 0.00% |

The data in Table 10-11 are summarized in Table 12 which lists azeotrope-like compositions (based on the equation: [(BP−VP)/BP]×100≤53).

TABLE 12

| | | E-HFO-1336mzz Liquid Mole |
|---|---|---|
| | Temp | Percentage Range |
| Components | (° C.) | (Remainder isopropanol) |
| E-HFO-1336mzz/Isopropanol | −40 | 0.998-0.999 |
| E-HFO-1336mzz/Isopropanol | −20 | 0.996-0.999 |
| E-HFO-1336mzz/Isopropanol | 0 | 0.992-0.999 |
| E-HFO-1336mzz/Isopropanol | 20 | 0.982-0.999 |
| E-HFO-1336mzz/Isopropanol | 29.88 | 0.976-0.999 |
| E-HFO-1336mzz/Isopropanol | 40 | 0.966-0.999 |
| E-HFO-1336mzz/Isopropanol | 60 | 0.940-0.999 |
| E-HFO-1336mzz/Isopropanol | 80 | 0.904-0.999 |
| E-HFO-1336mzz/Isopropanol | 100 | 0.858-0.999 |
| E-HFO-1336mzz/Isopropanol | 120 | 0.786-0.999 |
| E-HFO-1336mzz/Isopropanol | 140 | 0.724-0.999 |

### OTHER EMBODIMENTS

In some embodiments, the present application provides a composition comprising:

i) (E)-1,1,1,4,4,4-hexafluoro-2-butene; and

ii) a compound selected from ethanol and isopropanol;

wherein the ethanol or isopropanol is present in the composition in an amount effective to form an azeotrope or azeotrope-like composition with the (E)-1,1,1,4,4,4-hexafluoro-2-butene.

The composition of embodiment 1, wherein the composition comprises (E)-1,1,1,4,4,4-hexafluoro-2-butene and ethanol.

The composition of embodiment 1 or 2, wherein the composition is an azeotropic composition.

The composition of any one of embodiments 1 to 3, wherein the composition comprises about 79 to about 97 mole percent (E)-1,1,1,4,4,4-hexafluoro-2-butene and about 21 to about 3 mole percent ethanol at a temperature of about 60° C. to about 131° C. and a pressure of about 88 psia to about 441 psia.

The composition of any one of embodiments 1 to 3, wherein the composition comprises about 82 to about 97 mole percent (E)-1,1,1,4,4,4-hexafluoro-2-butene and about 18 to about 3 mole percent ethanol at a temperature of about 60° C. to about 120° C. and a pressure of about 83 psia to about 365 psia.

The composition of any one of embodiments 1 to 3, wherein the composition comprises about 82 to about 97 mole percent (E)-1,1,1,4,4,4-hexafluoro-2-butene and about 18 to about 3 mole percent ethanol at a temperature of about 60° C. to about 120° C. and a pressure of about 83 psia to about 365 psia.

The composition of embodiment 1 or 2, wherein the composition is an azeotrope-like composition.

The composition of any one of embodiments 1, 2, and 7, wherein the composition comprises about 72.8 to about 99.9 mole percent (E)-1,1,1,4,4,4-hexafluoro-2-butene and about 17.2 to about 0.1 mole percent ethanol at a temperature of about −40° C. to about 140° C. and a pressure of about 1.3 psia to about 507.9 psia.

The composition of any one of embodiments 1, 2, and 7, wherein the composition comprises:

about 99.6 to about 99.9 mole percent (E)-1,1,1,4,4,4-hexafluoro-2-butene and about 0.3 to about 0.1 mole percent ethanol at a temperature of about −40° C. and a pressure of about 1.3 psia to about 1.4 psia; or

about 99.2 to about 99.9 mole percent (E)-1,1,1,4,4,4-hexafluoro-2-butene and about 0.8 to about 0.1 mole percent ethanol at a temperature of about −20° C. a pressure of about 4.1 psia to about 4.2 psia;

about 98.2 to about 99.9 mole percent (E)-1,1,1,4,4,4-hexafluoro-2-butene and about 1.8 to about 0.1 mole percent ethanol at a temperature of about 0° C. and a pressure of about 10.3 psia to about 10.7 psia; or

about 96.8 to about 99.9 mole percent (E)-1,1,1,4,4,4-hexafluoro-2-butene and about 3.2 to about 0.1 mole percent ethanol at a temperature of about 20° C. and a pressure of about 22.8 psia to about 23.5 psia; or

about 96.0 to about 99.9 mole percent (E)-1,1,1,4,4,4-hexafluoro-2-butene and about 4.0 to about 0.1 mole percent ethanol at a temperature of about 29.9° C. and a pressure of about 32.2 psia to about 33.1 psia; or

about 94.8 to about 99.9 mole percent (E)-1,1,1,4,4,4-hexafluoro-2-butene and about 5.2 to about 0.1 mole percent ethanol at a temperature of about 40° C. and a pressure of about 44.5 psia to about 45.9 psia; or

about 92.2 to about 99.9 mole percent (E)-1,1,1,4,4,4-hexafluoro-2-butene and about 7.8 to about 0.1 mole percent ethanol at a temperature of about 60° C. and a pressure of about 80.7 psia to about 82.9 psia; or

about 88.6 to about 99.9 mole percent (E)-1,1,1,4,4,4-hexafluoro-2-butene and about 11.4 to about 0.1 mole percent ethanol at a temperature of about 80° C. and a pressure of about 137.1 psia to about 141.0 psia; or

about 84.4 to about 99.9 mole percent (E)-1,1,1,4,4,4-hexafluoro-2-butene and about 15.6 to about 0.1 mole percent ethanol at a temperature of about 100° C. and a pressure of about 226.8 psia to about 233.4 psia; or

about 78.4 to about 99.9 mole percent (E)-1,1,1,4,4,4-hexafluoro-2-butene and about 21.6 to about 0.1 mole percent ethanol at a temperature of about 120° C. and a pressure of about 353.2 psia to about 364.0 psia; or

about 72.8 to about 99.9 mole percent (E)-1,1,1,4,4,4-hexafluoro-2-butene and about 27.2 to about 0.1 mole percent ethanol at a temperature of about 140° C. and a pressure of about 492.9 psia to about 507.9 psia.

The composition of any one of embodiments 1 to 3 and 7, which is selected from the group of compositions provided in Table 2, Table 3, Table 4, Table 5, and Table 6.

The composition of embodiment 1, wherein the composition comprises (E)-1,1,1,4,4,4-hexafluoro-2-butene and isopropanol.

The composition of embodiment 1 or 11, wherein the composition is an azeotropic composition.

The composition of any one of embodiments 1, 11, and 12, wherein the composition comprises about 83 to about 96 mole percent (E)-1,1,1,4,4,4-hexafluoro-2-butene and about 17 to about 4 mole percent ethanol at a temperature of about 80° C. to about 120° C. and a pressure of about 139 psia to about 350 psia.

The composition of any one of embodiments 1, 11, and 12, wherein the composition comprises about 87 to about 99 mole percent (E)-1,1,1,4,4,4-hexafluoro-2-butene and about 13 to about 1 mole percent ethanol at a temperature of about 68° C. to about 108° C. and a pressure of about 103 psia to about 279 psia.

The composition of embodiment 1 or 11, wherein the composition is an azeotrope-like composition.

The composition of any one of embodiments 1, 11, and 15, wherein the composition comprises about 81.4 to about 99.9 mole percent (E)-1,1,1,4,4,4-hexafluoro-2-butene and about 18.6 to about 0.1 mole percent ethanol at a temperature of about −20° C. to about 120° C. and a pressure of about 46 psia to about 330 psia.

The composition of any one of embodiments 1, 11, and 15, wherein the composition comprises about 98.4 to about 99.9 mole percent (E)-1,1,1,4,4,4-hexafluoro-2-butene and about 1.6 to about 0.1 mole percent ethanol at a temperature of about 7.5° C. to about 7.8° C. and a pressure of about 14.7 psia.

The composition of any one of embodiments 1, 11, and 15, wherein the composition comprises:

about 99.6 to about 99.9 mole percent (E)-1,1,1,4,4,4-hexafluoro-2-butene and about 0.4 to about 0.1 mole percent ethanol at a temperature of about −20° C. and a pressure of about 4.1 psia to about 4.2 psia; or

about 99.2 to about 99.9 mole percent (E)-1,1,1,4,4,4-hexafluoro-2-butene and about 0.8 to about 0.1 mole percent ethanol at a temperature of about 0° C. and a pressure of about 10.4 psia to about 10.7 psia; or

about 98.2 to about 99.9 mole percent (E)-1,1,1,4,4,4-hexafluoro-2-butene and about 1.8 to about 0.1 mole percent ethanol at a temperature of about 20° C. and a pressure of from about 22.8 psia to about 23.7 psia; or

about 97.6 to about 99.9 mole percent (E)-1,1,1,4,4,4-hexafluoro-2-butene and about 2.4 to about 0.1 mole percent ethanol at a temperature of about 29.9° C. and a pressure of about 32.1 psia to about 33.4 psia; or

about 96.6 to about 99.9 mole percent (E)-1,1,1,4,4,4-hexafluoro-2-butene and about 2.4 to about 0.1 mole percent ethanol at a temperature of about 40° C. and a pressure of about 44.4 psia to about 46.4 psia; or

about 94.0 to about 99.9 mole percent (E)-1,1,1,4,4,4-hexafluoro-2-butene and about 6 to about 0.1 mole percent ethanol at a temperature of about 60° C. and a pressure of about 79.4 psia to about 83.0 psia; or

about 90.4 to about 99.9 mole percent (E)-1,1,1,4,4,4-hexafluoro-2-butene and about 9.6 to about 0.1 mole percent ethanol at a temperature of about 80° C. and a pressure of about 133.9 psia to about 138.4 psia; or

about 85.8 to about 99.9 mole percent (E)-1,1,1,4,4,4-hexafluoro-2-butene and about 14.2 to about 0.1 mole percent ethanol at a temperature of about 100° C. and a pressure of about 217.9 psia to about 226.0 psia; or

about 78.6 to about 99.9 mole percent (E)-1,1,1,4,4,4-hexafluoro-2-butene and about 21.4 to about 0.1 mole percent ethanol at a temperature of about 120° C. and a pressure of about 329.6 psia to about 347.5 psia.

The composition of any one of embodiments 1, 11, 12, and 15, which is selected from the group of compositions provided in Table 8, Table 9, Table 10, Table 11, and Table 12.

A process for producing cooling, comprising condensing the composition of any one of embodiments 1 to 19 and thereafter evaporating said composition in the vicinity of a body to be cooled.

A process for producing heating, comprising evaporating the composition of any one of embodiments 1 to 19 and thereafter condensing said composition in the vicinity of a body to be heated.

An air conditioning system, heat pump system, or refrigeration system comprising the composition of any one of embodiments 1 to 19.

The air conditioning system, heat pump system, or refrigeration system of embodiment 22, wherein the system comprises an evaporator, compressor, condenser, and expansion device.

The air conditioning system, heat pump system, or refrigeration system of embodiment 22, wherein said system comprises one or more heat exchangers that operate in counter-current mode or cross-current mode with counter-current tendency.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

What is claimed is:

1. A composition, comprising:
i) (E)-1,1,1,4,4,4-hexafluoro-2-butene; and
ii) a compound selected from ethanol and isopropanol;
wherein the ethanol or isopropanol is present in the composition in an amount effective to form an azeotrope or azeotrope-like composition with the (E)-1,1,1,4,4,4-hexafluoro-2-butene.

2. The composition of claim 1, wherein the composition comprises (E)-1,1,1,4,4,4-hexafluoro-2-butene and ethanol.

3. The composition of claim 2, wherein the composition is an azeotropic composition.

4. The composition of claim 3, wherein the composition comprises about 79 to about 97 mole percent (E)-1,1,1,4,4,4-hexafluoro-2-butene and about 21 to about 3 mole percent ethanol at a temperature of about 60° C. to about 131° C. and a pressure of about 88 psia to about 441 psia.

5. The composition of claim 3, wherein the composition comprises about 82 to about 97 mole percent (E)-1,1,1,4,4,4-hexafluoro-2-butene and about 18 to about 3 mole percent ethanol at a temperature of about 60° C. to about 120° C. and a pressure of about 83 psia to about 365 psia.

6. The composition of claim 3, wherein the composition comprises about 82 to about 97 mole percent (E)-1,1,1,4,4,4-hexafluoro-2-butene and about 18 to about 3 mole percent ethanol at a temperature of about 60° C. to about 120° C. and a pressure of about 83 psia to about 365 psia.

7. The composition of claim 2, wherein the composition is an azeotrope-like composition.

8. The composition of claim 7, wherein the composition comprises about 72.8 to about 99.9 mole percent (E)-1,1,1,4,4,4-hexafluoro-2-butene and about 17.2 to about 0.1 mole percent ethanol at a temperature of about −40° C. to about 140° C. and a pressure of about 1.3 psia to about 507.9 psia.

9. The composition of claim 7, wherein the composition comprises:
about 99.6 to about 99.9 mole percent (E)-1,1,1,4,4,4-hexafluoro-2-butene and about 0.3 to about 0.1 mole percent ethanol at a temperature of about −40° C. and a pressure of about 1.3 psia to about 1.4 psia; or
about 99.2 to about 99.9 mole percent (E)-1,1,1,4,4,4-hexafluoro-2-butene and about 0.8 to about 0.1 mole percent ethanol at a temperature of about −20° C. a pressure of about 4.1 psia to about 4.2 psia;
about 98.2 to about 99.9 mole percent (E)-1,1,1,4,4,4-hexafluoro-2-butene and about 1.8 to about 0.1 mole percent ethanol at a temperature of about 0° C. and a pressure of about 10.3 psia to about 10.7 psia; or
about 96.8 to about 99.9 mole percent (E)-1,1,1,4,4,4-hexafluoro-2-butene and about 3.2 to about 0.1 mole percent ethanol at a temperature of about 20° C. and a pressure of about 22.8 psia to about 23.5 psia; or
about 96.0 to about 99.9 mole percent (E)-1,1,1,4,4,4-hexafluoro-2-butene and about 4.0 to about 0.1 mole percent ethanol at a temperature of about 29.9° C. and a pressure of about 32.2 psia to about 33.1 psia; or
about 94.8 to about 99.9 mole percent (E)-1,1,1,4,4,4-hexafluoro-2-butene and about 5.2 to about 0.1 mole percent ethanol at a temperature of about 40° C. and a pressure of about 44.5 psia to about 45.9 psia; or
about 92.2 to about 99.9 mole percent (E)-1,1,1,4,4,4-hexafluoro-2-butene and about 7.8 to about 0.1 mole percent ethanol at a temperature of about 60° C. and a pressure of about 80.7 psia to about 82.9 psia; or
about 88.6 to about 99.9 mole percent (E)-1,1,1,4,4,4-hexafluoro-2-butene and about 11.4 to about 0.1 mole percent ethanol at a temperature of about 80° C. and a pressure of about 137.1 psia to about 141.0 psia; or
about 84.4 to about 99.9 mole percent (E)-1,1,1,4,4,4-hexafluoro-2-butene and about 15.6 to about 0.1 mole percent ethanol at a temperature of about 100° C. and a pressure of about 226.8 psia to about 233.4 psia; or
about 78.4 to about 99.9 mole percent (E)-1,1,1,4,4,4-hexafluoro-2-butene and about 21.6 to about 0.1 mole percent ethanol at a temperature of about 120° C. and a pressure of about 353.2 psia to about 364.0 psia; or
about 72.8 to about 99.9 mole percent (E)-1,1,1,4,4,4-hexafluoro-2-butene and about 27.2 to about 0.1 mole percent ethanol at a temperature of about 140° C. and a pressure of about 492.9 psia to about 507.9 psia.

10. The composition of claim 1, wherein the composition comprises (E)-1,1,1,4,4,4-hexafluoro-2-butene and isopropanol.

11. The composition of claim 10, wherein the composition is an azeotropic composition.

12. The composition of claim 11, wherein the composition comprises about 83 to about 96 mole percent (E)-1,1,1,4,4,4-hexafluoro-2-butene and about 17 to about 4 mole percent ethanol at a temperature of about 80° C. to about 120° C. and a pressure of about 139 psia to about 350 psia.

13. The composition of claim 11, wherein the composition comprises about 87 to about 99 mole percent (E)-1,1,1,4,4,4-hexafluoro-2-butene and about 13 to about 1 mole percent ethanol at a temperature of about 68° C. to about 108° C. and a pressure of about 103 psia to about 279 psia.

14. The composition of claim 10, wherein the composition is an azeotrope-like composition.

15. The composition of claim 14, wherein the composition comprises about 81.4 to about 99.9 mole percent (E)-1,1,1,4,4,4-hexafluoro-2-butene and about 18.6 to about 0.1 mole percent ethanol at a temperature of about −20° C. to about 120° C. and a pressure of about 46 psia to about 330 psia.

16. The composition of claim 14, wherein the composition comprises about 98.4 to about 99.9 mole percent (E)-1,1,1,4,4,4-hexafluoro-2-butene and about 1.6 to about 0.1 mole percent ethanol at a temperature of about 7.5° C. to about 7.8° C. and a pressure of about 14.7 psia.

17. The composition of claim 14, wherein the composition comprises:
about 99.6 to about 99.9 mole percent (E)-1,1,1,4,4,4-hexafluoro-2-butene and about 0.4 to about 0.1 mole percent ethanol at a temperature of about −20° C. and a pressure of about 4.1 psia to about 4.2 psia; or
about 99.2 to about 99.9 mole percent (E)-1,1,1,4,4,4-hexafluoro-2-butene and about 0.8 to about 0.1 mole percent ethanol at a temperature of about 0° C. and a pressure of about 10.4 psia to about 10.7 psia; or
about 98.2 to about 99.9 mole percent (E)-1,1,1,4,4,4-hexafluoro-2-butene and about 1.8 to about 0.1 mole percent ethanol at a temperature of about 20° C. and a pressure of from about 22.8 psia to about 23.7 psia; or
about 97.6 to about 99.9 mole percent (E)-1,1,1,4,4,4-hexafluoro-2-butene and about 2.4 to about 0.1 mole percent ethanol at a temperature of about 29.9° C. and a pressure of about 32.1 psia to about 33.4 psia; or
about 96.6 to about 99.9 mole percent (E)-1,1,1,4,4,4-hexafluoro-2-butene and about 2.4 to about 0.1 mole percent ethanol at a temperature of about 40° C. and a pressure of about 44.4 psia to about 46.4 psia; or
about 94.0 to about 99.9 mole percent (E)-1,1,1,4,4,4-hexafluoro-2-butene and about 6 to about 0.1 mole percent ethanol at a temperature of about 60° C. and a pressure of about 79.4 psia to about 83.0 psia; or
about 90.4 to about 99.9 mole percent (E)-1,1,1,4,4,4-hexafluoro-2-butene and about 9.6 to about 0.1 mole percent ethanol at a temperature of about 80° C. and a pressure of about 133.9 psia to about 138.4 psia; or
about 85.8 to about 99.9 mole percent (E)-1,1,1,4,4,4-hexafluoro-2-butene and about 14.2 to about 0.1 mole percent ethanol at a temperature of about 100° C. and a pressure of about 217.9 psia to about 226.0 psia; or
about 78.6 to about 99.9 mole percent (E)-1,1,1,4,4,4-hexafluoro-2-butene and about 21.4 to about 0.1 mole percent ethanol at a temperature of about 120° C. and a pressure of about 329.6 psia to about 347.5 psia.

18. A process for producing cooling, comprising condensing the composition of claim 1 and thereafter evaporating said composition in the vicinity of a body to be cooled.

19. A process for producing heating, comprising evaporating the composition of claim 1 and thereafter condensing said composition in the vicinity of a body to be heated.

20. An air conditioning system, heat pump system, or refrigeration system comprising the composition of claim 1.

21. The air conditioning system, heat pump system, or refrigeration system of claim 20, wherein the system comprises an evaporator, compressor, condenser, and expansion device.

22. The air conditioning system, heat pump system, or refrigeration system of claim 20, wherein said system comprises one or more heat exchangers that operate in counter-current mode or cross-current mode with counter-current tendency.
